(19) United States
(12) Patent Application Publication
(10) Pub. No.: US 2026/0089301 A1
(43) Pub. Date: Mar. 26, 2026

(54) VISION SYSTEMS WITH DIFFERENT PERCEPTION HARDWARE CONFIGURATIONS FOR PROVIDING DIFFERENT FIELDS OF VIEW

(71) Applicant: SARONIC TECHNOLOGIES, Austin, TX (US)

(72) Inventors: Joseph Fox-Rabinovitz, Austin, TX (US); Dana Wieland, Austin, TX (US); Abraham Skandera, Austin, TX (US); Jason Lang, Austin, TX (US); Jacob Freeman, Austin, TX (US); Douglas Lambert, Austin, TX (US)

(21) Appl. No.: 19/337,592

(22) Filed: Sep. 23, 2025

Related U.S. Application Data
(60) Provisional application No. 63/698,013, filed on Sep. 23, 2024.
(60) Provisional application No. 63/742,533, filed on Jan. 7, 2025.

(51) Int. Cl. H04N 13/243; B63B 49/00; H04N 23/20; H04N 23/90

(52) U.S. Cl. CPC H04N 13/243; B63B 49/00; H04N 23/20; H04N 23/90

(57) ABSTRACT

A vision system including a frame including first and second openings and a stereovision camera disposed within the frame. The stereovision camera includes a first image sensor with a first field of view (FOV) having a first optical axis, the first image sensor being disposed immediately adjacent to the first opening, and a second image sensor with a second FOV having a second optical axis, the second image sensor being disposed immediately adjacent to the second opening. Both the first image sensor and the second image sensor are passive sensors. The second optical axis is not parallel with the first optical axis and/or the first FOV is larger than the second FOV.

### CROSS-REFERENCE TO RELATED APPLICATIONS

The present application claims priority to U.S. Provisional Patent Application No. 63/698,013, titled “Perception Hardware Configurations for Maritime Vehicle” and filed Sep. 23, 2024, and U.S. Provisional Patent Application No. 63/742,533, titled “Perception Hardware Configurations for Maritime Vehicle” and filed Jan. 7, 2025. The contents of these applications are hereby incorporated by reference in their entirety.

### FIELD OF THE DISCLOSURE

The present disclosure generally relates to vision systems and more specifically to vision systems having different perception hardware configurations for providing different fields of view.

### BACKGROUND OF THE DISCLOSURE

Maritime vehicles, or vehicles designed for use on or in the water, are commonly used for transportation, recreation, defense, scientific research, and other purposes. Examples of maritime vehicles include boats, watercraft, submarines, and amphibious vehicles. Maritime vehicles can be manned (i.e., operated by an onboard human) or unmanned, and unmanned maritime vehicles can be remotely controlled or can be autonomous.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identify like elements in the several FIGS., in which:

FIG. 1A is a top perspective view of an example of a maritime vehicle constructed in accordance with the teachings of the present disclosure, the maritime vehicle including one example of a vision system constructed in accordance with the teachings of the present disclosure;

FIG. 1B is a front view of the maritime vehicle of FIG. 1A, but with the latching assembly of the maritime vehicle removed for illustrative purposes;

FIG. 1C is a rear view of the maritime vehicle of FIG. 1B;

FIG. 1D is a bottom perspective view of the maritime vehicle of FIG. 1B;

FIG. 1E is a side view of the maritime vehicle of FIG. 1B;

FIG. 1F is similar to FIG. 1A, but with the cap and various components of the maritime vehicle removed for illustrative purposes;

FIG. 1G is similar to FIG. 1F, but with the latching assembly and additional components of the maritime vehicle removed for illustrative purposes;

FIG. 1H is a rear, perspective view of the maritime vehicle of FIG. 1F;

FIG. 1I is a first cross-sectional view taken along line I-I in FIG. 1A;

FIG. 1J is a second cross-sectional view taken along line J-J in FIG. 1A;

FIG. 1K is similar to FIG. 1A, but shows the fields of view of two image sensors of the vision system of the maritime vehicle;

FIG. 2A is a front, perspective view of the vision system employed in the maritime vehicle of FIGS. 1A-1K;

FIG. 2B is another front, perspective view of the vision system of FIG. 2A;

FIG. 2C is a front, perspective view of a housing of the vision system of FIG. 2A;

FIG. 2D is an exploded view of the housing of FIG. 2C;

FIG. 2E is another front, perspective view of the vision system of FIG. 2A;

FIG. 2F is a rear, perspective view of a camera module and an electronics plate of the vision system of FIG. 2A;

FIG. 2G is a front, exploded view of the camera module;

FIG. 2H is a rear, exploded view of the camera module;

FIG. 2I is a front, perspective view of a window retention plate of the camera module;

FIG. 2J is a rear view of FIG. 2I;

FIG. 2K is a top view of FIG. 2I;

FIG. 2L is a cross-sectional view taken along line L-L in FIG. 2K;

FIG. 2M is a perspective view of an electro-optical camera of the vision system of FIG. 2A;

FIG. 2N is a perspective view of a bracket for the electro-optical camera of FIG. 2M;

FIG. 2O is a perspective view of a bracket for infrared cameras of the vision system of FIG. 2A;

FIG. 2P is a front, perspective view of the electronics plate of the vision system of FIG. 2A;

FIG. 2Q is a rear, perspective view of the electronics plate;

FIG. 2R illustrates the electronics plate being coupled to the housing;

FIG. 2S is a cross-sectional view of the vision system of FIG. 2A;

FIG. 2T is an exploded view of the vision system of FIG. 2A;

FIG. 2U is a front, perspective view illustrating the orientation of the vision system of FIG. 2A when installed in the maritime vehicle of FIGS. 1A-1K; and

FIG. 2V is a side view of FIG. 2U;

FIG. 2W is a rear, perspective view of FIG. 2U;

FIG. 2X is a top view of the field of vision of the vision system of FIG. 2A when in operation;

FIGS. 2Y and 2Z are side views of the field of vision of the vision system of FIG. 2A when in operation; and

FIGS. 3A-3F depict various examples of perception hardware configurations for the vision system of FIG. 2A and corresponding fields of view (FOVs) produced by the perception hardware configurations, constructed in accordance with the teachings of the present disclosure.

### DETAILED DESCRIPTION

The present disclosure is directed to vision systems having different perception techniques/systems. The vision systems described herein are intended for use in a maritime vehicle that is primarily intended for use for military purposes (e.g., for naval defense, patrolling waters and enforcing laws, reconnaissance, naval exploration, monitoring) but can also be used for other purposes if desired. However, the vision systems can be employed in a different type of vehicle or any other system that could benefit from a stereo vision perception system. For example, the perception techniques/systems described herein may be implemented for autonomous and semi-autonomous land vehicles, non-autonomous driver assist systems, manipulative robots (e.g., surgical robots, drones), and/or any vehicle or system that could benefit from a stereo vision perception system.

The maritime vehicle is small (er), durable, and configured to quickly, efficiently, and stealthily traverse a body of water once dispatched (e.g., from other maritime vehicles, beachheads, or an airdrop). The maritime vehicle is modular, with components that can be flexibly altered, removed, or added as desired in accordance with the mission of the maritime vehicle. The maritime vehicle can collaborate with other similar maritime vehicles and/or military assets when necessary. The maritime vehicle is preferably unmanned and autonomous (e.g., an autonomous maritime surface vehicle (AMSV)), though need not be.

Additionally, the perception techniques/systems of the present disclosure allow an AMSV to accurately, reliably, and passively sense, perceive/detect, and identify targets within a marine, littoral, riparian, or other environment. More specifically, the techniques/systems of the present disclosure sense radiation from an external environment of an AMSV using a passive sensing system (e.g., a stereovision infrared (IR) camera) to detect objects within data representative of the radiation. The techniques/systems of the present disclosure thereby improve over conventional perception techniques/systems at least by accurately and reliably detecting targets in two and three dimensions within an AMSV external environment (e.g., marine environment) without emitting radiation detectable by such targets.

Conventional marine sensing systems and perception techniques/systems frequently rely on active sensing components (i.e., components that actively emit, and subsequently capture, radiation) to detect objects proximate to a marine vessel. These active sensing components are often coupled with passive sensing components (i.e., components that only capture radiation) to, for example, improve overall data capture capabilities or increase data intake at particular wavelengths, and/or estimate depth through travel time (e.g., RADAR). However, such conventional techniques/systems suffer from several notable drawbacks.

As one example, active sensing systems create significant amounts of noise and/or otherwise detectable radiation. Other vessels proximate to a marine vessel utilizing an active sensing system can readily sense this radiation, such that the marine vessel effectively sacrifices its stealth and any attendant benefits from remaining undetected (e.g., safety in combat scenarios). For vessels performing activities/missions requiring a high degree of stealth (e.g., reconnaissance, target tracking, etc.), conventional active sensing systems jeopardize the activities/missions, as well as the vessels themselves and (for manned vehicles) the lives of their crews.

Further, conventional marine sensing systems may utilize stereoscopic vision (also referenced herein as “stereovision”) techniques to determine depth information associated with sensed objects. The accuracy of any depth value resulting from stereoscopic images is directly proportional to the baseline length between the two image sensors comprising the stereoscopic camera system, and many marine vessels have limited space to accommodate a large baseline distance. As a result, conventional stereoscopic imaging techniques in many marine environments may yield insufficiently accurate depth values. This poses a significant challenge, for example, for collision avoidance when in close proximity to a friendly (or non-targeted) object or in circumstances where the position of a target is a mission critical value requiring pinpoint accuracy, such as when a marine vessel is tracking and/or intends to engage the target.

Moreover, conventional marine sensing systems employing stereoscopic vision typically utilize identically sized fields of view (FOVs) with parallel optical axes. This configuration underutilizes the individual imagers comprising the stercovision camera by orienting the imagers in the same direction and/or creates blind spots near the edges of the vessel (e.g., bow, stern, port side, starboard side, depending on the orientation of the stereoscopic system), and experiences difficulties when the desired combined FOV of the stereovision system is broader or narrower than the identically sized FOVs of the two image sensors. The blind spots create a substantial challenge for effective vessel navigation relative to proximate objects (e.g., within 10 fect), and the identically sized FOVs may lack the breadth to capture the entire vessel environment and/or the resolution to identify objects within a particular region of interest. Further, having multiple imagers oriented in the same direction generally adds size, weight, and/or consumes additional power for minimal/negligible additional benefit.

By contrast, the present disclosure provides AMSV perception techniques/systems that overcome several of these issues experienced by conventional techniques/systems to achieve accurate and reliable target sensing, perception/detection, and identification. Namely, the present techniques/systems generally utilize a completely passive sensing system (e.g., stereovision IR camera system) to detect radiation in an external environment of an AMSV and ultimately detect objects indicated by data representative of the radiation. In doing so, the techniques/systems of the present disclosure overcome the significant noise/detection issues experienced by conventional techniques/systems that rely on active sensing systems to detect proximate objects in a marine environment. The present techniques/systems eliminate the emitted radiation resulting from using active sensing system radiation emissions, thereby preserving the stealth of the AMSV's relative to proximate vessels. These advantages are further amplified by utilizing IR sensors that can operate in low-light (e.g., night-time) environments without sacrificing visibility. Consequently, the present techniques/systems improve over conventional marine sensing systems at least by enabling the AMSV to operate effectively while remaining undetected during activities/missions requiring stealth, such that the activities/missions and the AMSV have a larger probability of success.

In certain examples, the present techniques/systems include sensing radiation from an external environment of an AMSV using a sensing system that includes at least a stercovision camera with (i) a first image sensor with a first FOV having a first optical axis and (ii) a second image sensor with a second FOV having a second optical axis that is not parallel with the first optical axis.

By utilizing two sensors with FOVs having non-parallel optical axes, the techniques/systems of the present disclosure overcome the navigation challenges experienced by conventional techniques/systems. In particular, the two sensors create a shared FOV (referenced herein as a “stereoscopic FOV”) that is significantly closer to the edge (e.g., the bow) of the AMSV than was previously accomplished using conventional techniques/systems. This configuration thus enables the AMSV to navigate accurately and efficiently relative to objects within the marine environment at distances significantly closer to the AMSV (e.g., less than 10 fect) than conventional techniques/systems allowed. As a result, the AMSV is able to plan and execute navigation routes with greater accuracy and precision than was previously possible, leading to more efficient/optimal routing, reduced inadvertent/unintentional collisions with proximate objects, and higher mission success rates for a given cost.

Of course, it should be appreciated that the advantages and technical improvements described above and elsewhere herein are not the only advantages and/or technical improvements that may be realized as a result of the techniques/systems described herein. Other advantages and/or technical improvements to the functioning of a computer itself or other technologies or technical fields may be apparent to one of ordinary skill in the art. Moreover, while described herein primarily in the maritime context, the techniques/systems described herein may be readily applied in any suitable field for any suitable purpose.

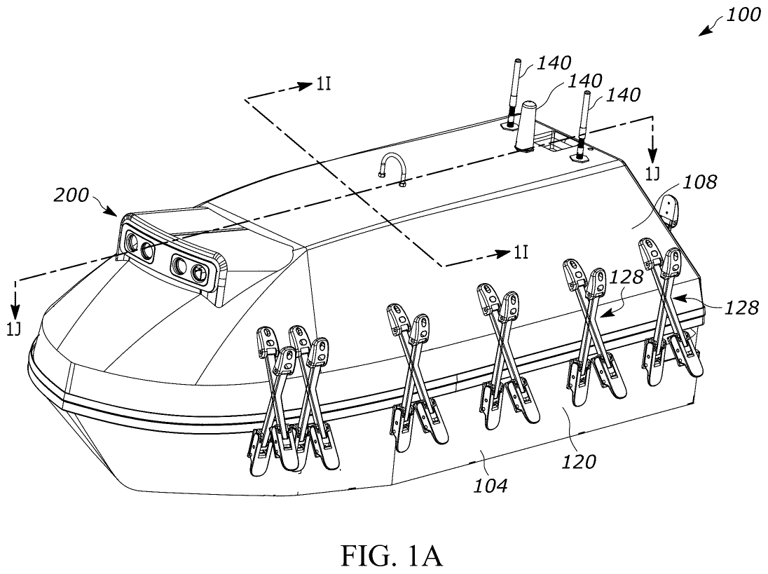

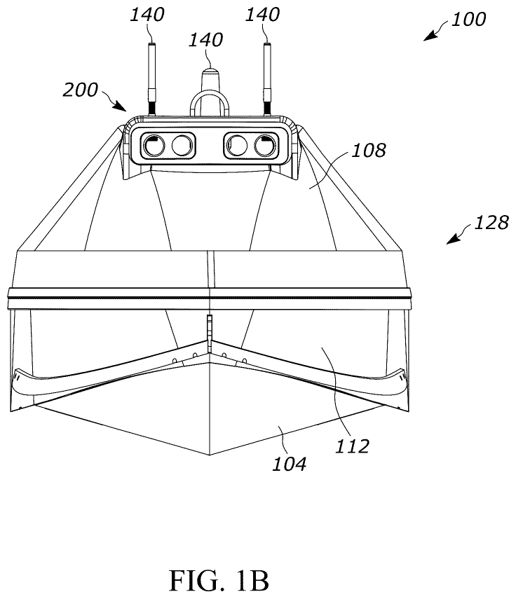

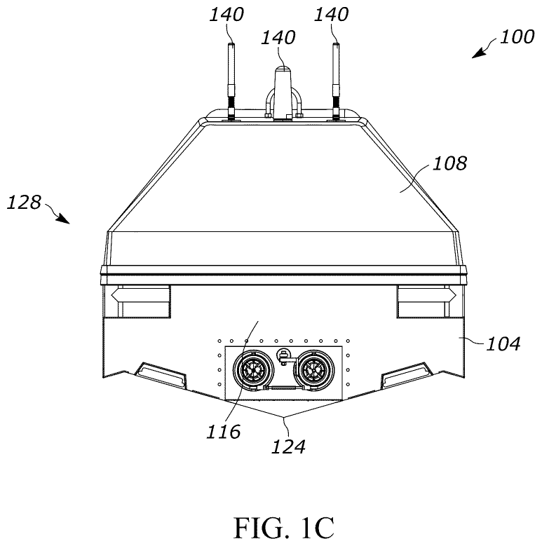

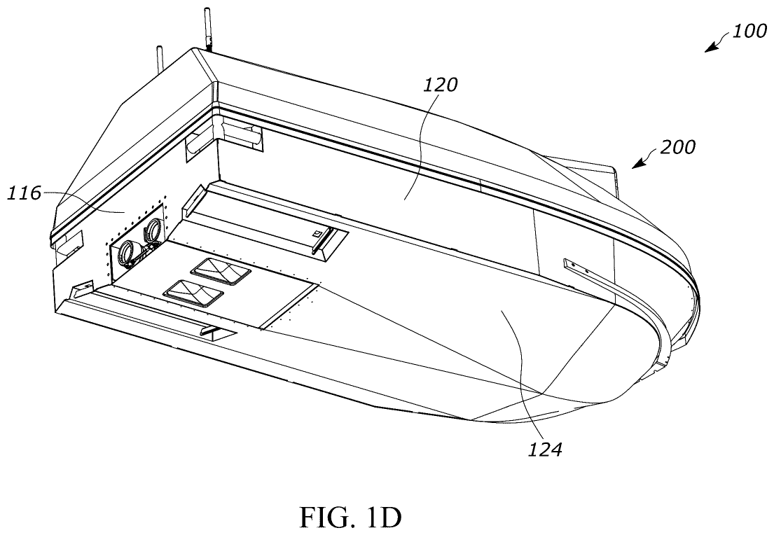

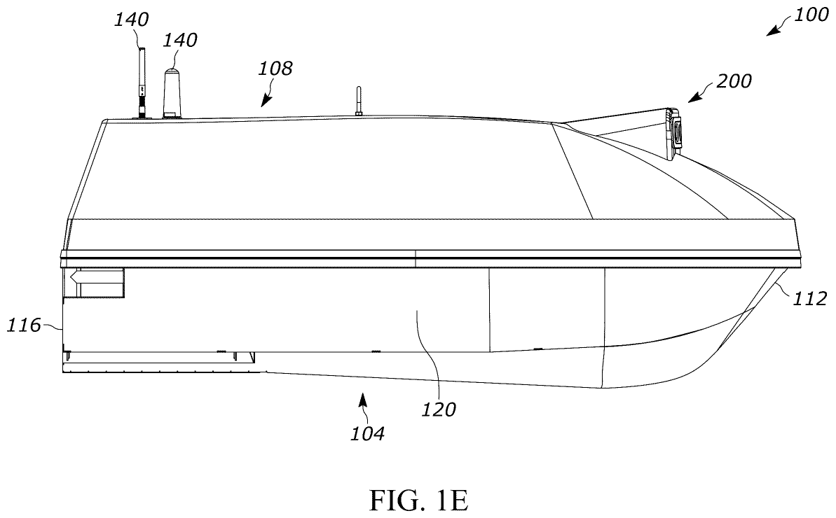

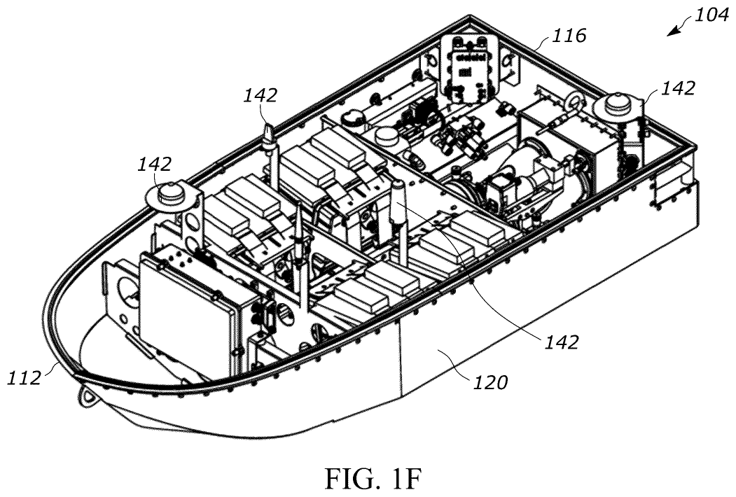

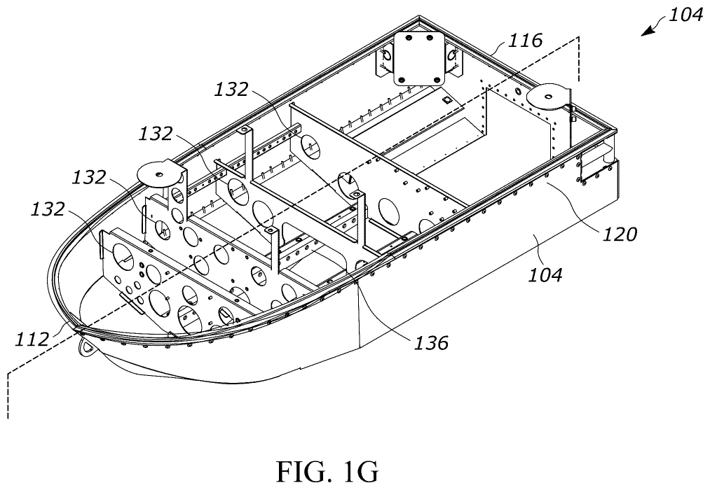

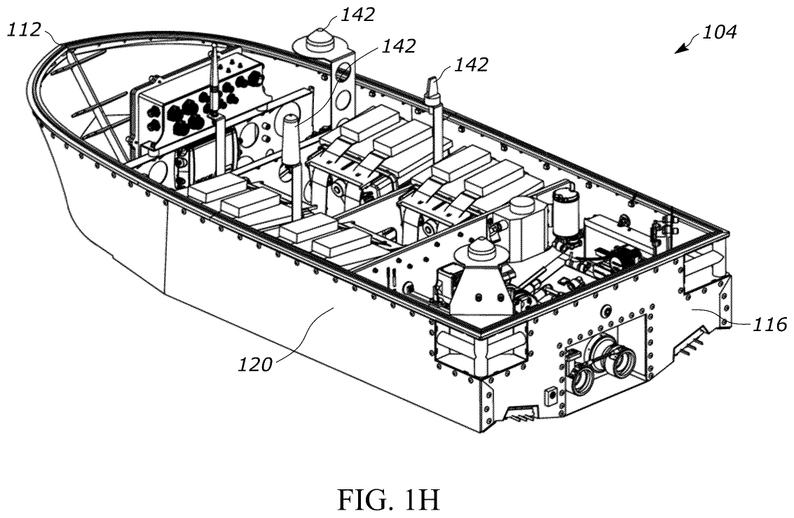

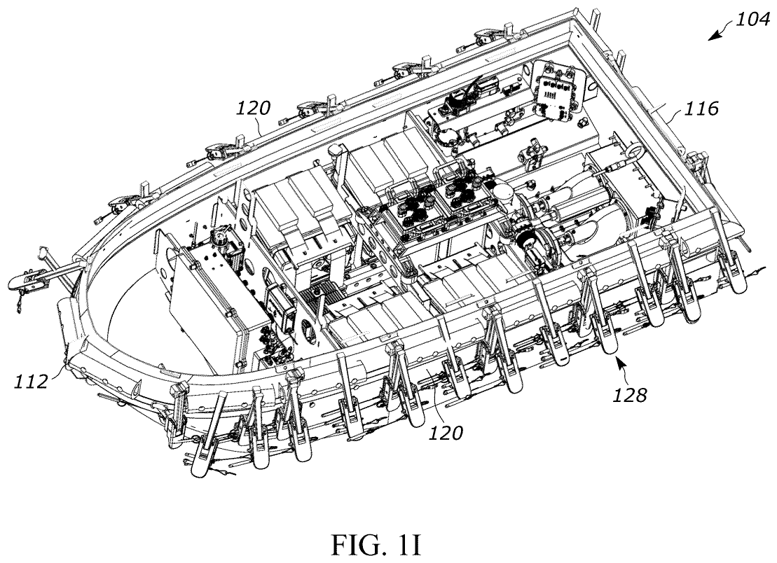

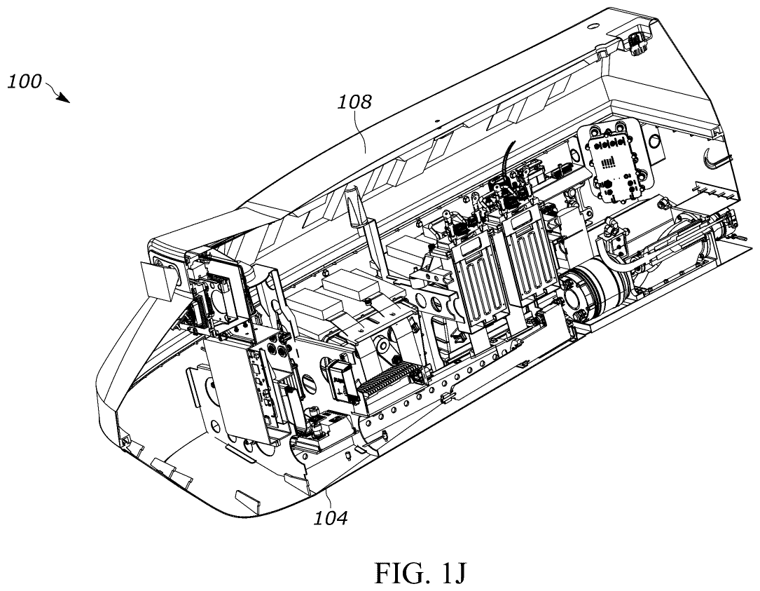

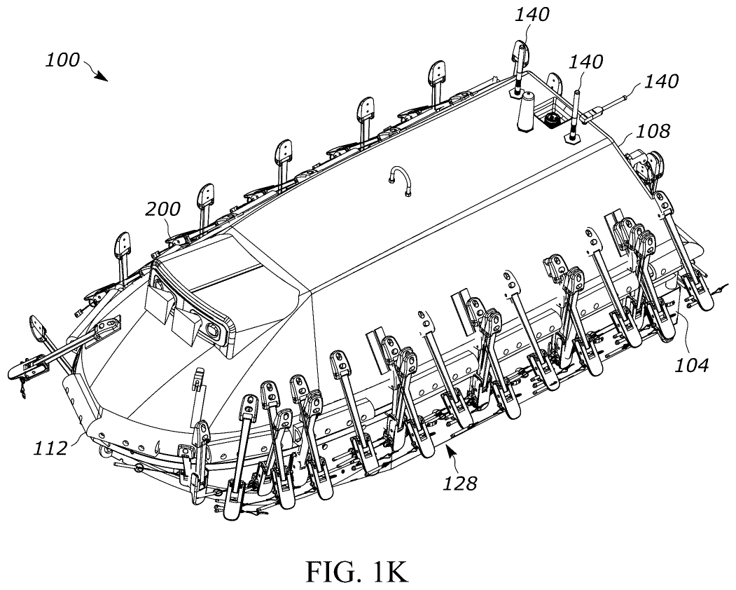

FIGS. 1A-1K illustrate one example of a maritime vehicle 100 constructed in accordance with the teachings of the present disclosure. The maritime vehicle 100 is an unmanned vessel configured to autonomously traverse a body of water. The maritime vehicle 100 generally includes a hull 104 and a cap 108 that is coupled to the hull 104 to secure various components within the maritime vehicle 100. The hull 104 is at least partially disposed in the body of water in which the maritime vehicle 100 is traversing. The hull 104 in this example is a mono-hull that has a front (or bow) 112, a rear (or stern) 116, two sides 120, and a keel 124 coupled to another. The front 112, the rear 116, the sides 120, and the keel 124 can be welded together or can be coupled to one another in a different manner. For example, the front 112, the rear 116, the sides 120, and the keel 124 can be coupled together in the manner described in U.S. Provisional Application No. 63/561,282, titled “Systems and Approaches for Assembling a Maritime Vehicle” and filed Mar. 4, 2024, the contents of which are hereby incorporated by reference herein. The hull 104 is configured such that the hull provides a continuous planning surface that allows the maritime vehicle 100 to be highly maneuverable and to ride along the top of a body of water at high speeds, even in extreme weather conditions and difficult to navigate bodies of water. Meanwhile, the cap 108 is coupled to the hull 104 to cover and/or conceal the components of the maritime vehicle 100 disposed in and carried by the hull 104 as the maritime vehicle 100 traverses the body of water.

In this example, the hull 104 and the cap 108 each have a length that is equal to approximately 6 feet. In other examples, however, the length can vary. For example, the length can be equal to approximately 14 feet or approximately 25 feet. The hull 104 is preferably entirely made of aluminum but can be partially or entirely be made of fiberglass and/or one or more other materials. In other examples, the maritime vehicle 100 can include two or more hulls (e.g., two parallel hulls) instead of a mono-hull. In this example, the cap 108 entirely covers the hull 104 (and the components therein). In other examples, however, the maritime vehicle 100 need not include the cap 108 or the cap 108 may only partially cover the hull 104 (and the components disposed therein).

In some examples, the cap 108 can be removably coupled to the hull 104 via a locking system. For example, as illustrated in FIGS. 1A-1K, the locking system 128 can take the form of a plurality of latch mechanisms 128 disposed around a perimeter of the maritime vehicle 100. Thus, the cap 108 can be removed to allow access to the interior of the hull 104. In other examples, however, the cap 108 can be permanently coupled to the hull 104 to permanently conceal the components within the maritime vehicle 100.

The maritime vehicle 100 also includes a plurality of bulkheads 132 arranged within the hull 104. The bulkheads 132 divide the maritime vehicle 100 into a plurality of different compartments for receiving and retaining different components in the maritime vehicle 100.

The maritime vehicle 100 also includes a sensor system (which is also referred to herein as a sensing system) that is generally configured to collect data about various components of the maritime vehicle 100 as well as data about the environment surrounding the maritime vehicle 100 (including data about objects in that environment). To this end, the sensor system generally includes a plurality of sensors disposed on an exterior or an interior of the maritime vehicle 100. The sensors can include, for example, one or more pressure sensors (e.g., positioned to detect the pressure of the ambient air external to the maritime vehicle 100, the pressure of the water in which the maritime vehicle 100 is disposed, the pressure within the maritime vehicle 100, the pressure within individual components of the maritime vehicle 100), one or more temperature sensors (e.g., positioned to measure a temperature of a component of the maritime vehicle 100, a temperature of ambient air external to the maritime vehicle 100, a temperature of water in which the maritime vehicle 100 is disposed), one or more acoustic sensors (e.g., sonar sensors), one or more LIDAR sensors, an inertial navigation system (INS) (e.g., one or more location sensors (e.g., GPS sensors), one or more pose sensors (e.g., compass sensors), one or more motion sensors (e.g., accelerometers, gyroscopes)), one or more water sensors (e.g., a float switch, a capacitive sensor, an ultrasonic sensor, an electrical water sensor, etc.) to determine when water is present and/or present to a given extent (e.g., at a certain volume or level), one or more humidity sensors, one or more power sensors (e.g., configured to detect charging or fueling levels), one or more lighting sensors (e.g., daylight sensors), one or more image sensors (e.g., CCD sensors, CMOS sensors, IR image sensors, EO sensors), one or more magnetic sensors, or combinations thereof. The sensing system also generally includes a vision system 200 that is generally configured to capture (e.g., via one or more cameras including one or more image sensors), process, correlate, and analyze images obtained by the one or more image sensors and other data (e.g., data obtained by other sensors in the sensor system). The vision system 200 can in turn identify or classify the environment surrounding the maritime vehicle 100 (including objects in that environment).

The maritime vehicle 100 also includes a power system that is generally configured to power the maritime vehicle 100 (and the components of the maritime vehicle 100). The power system generally includes a thrust system and one or more power sources configured to power the thrust system (and the other components within the maritime vehicle 100). The thrust system is generally configured to propel the maritime vehicle 100 in/on/along the water. The thrust system can be a propeller-based thrust system or can be a jet pump-based thrust system. The one or more power sources can include, for example, one or more batteries, fuel (e.g., gasoline, diesel) stored in tanks carried by the maritime vehicle 100, hydrogen stored in hydrogen tanks carried by the maritime vehicle 100, solar panels (e.g., mounted to an exterior of the vehicle 100), or other sources. The maritime vehicle 100 illustrated in FIGS. 1A-1K includes four battery assemblies each including a rechargeable battery. The maritime vehicle 100 generally also includes a cooling system configured to cool the thrust system and/or the one or more power sources, thereby preventing these components from overheating and leading to failure of the maritime vehicle 100. The power sources supply power to various components of the maritime vehicle 100, and thereby enable operation of, for example, the sensor system to passively detect/track objects within the environment of the maritime vehicle 100.

In operation, the maritime vehicle 100 may be used to deploy and/or retrieve payloads such as, for example, persons, weapons (e.g., drones, missiles, mines, bombs), cargo (e.g., food), scientific instruments, or other equipment. Payloads can be deployed acrially (into the air), underwater, or on the surface of the water. Payloads can also be retrieved from the air, from underwater, or the surface of the water. Payloads to be deployed can be disposed in the hull 104, attached to the exterior surface of the hull 104, attached to the exterior surface of the cap 108 prior to deployment, or placed through openings in the hull 104, with or without hatches or other covers over the openings. Likewise, retrieved payloads can be stored in the hull 104, attached to and stored on the exterior surface of the hull 104, or attached to and stored on the exterior surface of the cap 108.

The maritime vehicle 100 can also include other systems to help with the operation of the maritime vehicle 100, for example a ballast system and a navigation system. The ballast system is generally configured to stabilize the maritime vehicle 100 in the water, regardless of whether the maritime vehicle 100 is stationary or on the move. To this end, the maritime vehicle 100 may include one or more ballast tanks or chambers selectively filled with water or air to vary the buoyancy of the maritime vehicle 100. Alternatively or additionally, the ballast system may include and utilize one or more inflatable devices to vary the buoyancy of the maritime vehicle 100. The ballast system may also provide for the selective submerging and re-surfacing of the maritime vehicle 100 in a similar manner. The navigation system, which may for example be an INS, utilizes the sensors of the sensor system to track the position and orientation of the maritime vehicle 100 and to guide the maritime vehicle 100 to its desired location in the body of water (or in a different body of water).

The maritime vehicle 100 further includes a communications system that is generally configured to facilitate communication (i) between the maritime vehicle 100 and one or more central (remote) controllers, (ii) between the maritime vehicle 100 and and/or one or more other maritime vehicles 100 and/or other military assets (e.g., planes, ships), and (iii) between different components of the maritime vehicle 100. The communications system generally includes one or more local controllers and one or more communication modules (e.g., one or more antennae, one or more receivers, one or more transmitters, one or more radios, one or more ethernet switches) to effectuate wired or wireless communication between the maritime vehicle 100 and the central controller(s) or other maritime vehicles 100. For example, the maritime vehicle 100 includes a plurality of antennae 140 disposed on an exterior of the cap 108 as well as a plurality of antennae 142 disposed in the hull 104. The antennae 140, 142 can also be used as part of the sensor system described herein by, for example, receiving signals from emitting devices and reporting the physical characteristics of the carrier signals, even if the intended informational content is unintelligible.

The one or more local controllers are generally configured to communicate data (e.g., operational instructions, data from the sensor system, data from other maritime vehicles 100 or military assets) and to perform automated operations of the maritime vehicle 100 based on that data. In some examples, the maritime vehicle 100 includes a plurality of different local controllers. For example, the maritime vehicle 100 can include one or more thrust controllers (for controlling the operation of the thrust system), one or more sensor controllers (for controlling the sensors in the sensor system), one or more payload controllers (for deploying or retrieving payloads), one or more navigation controllers (as part of the navigation system), and one or more ballast controllers (for controlling the ballast system). It will be appreciated that each of the one or more controllers may be implemented as hardware (e.g., processor, die, integrated device), software (e.g., non-transitory processor readable medium), and/or combinations thereof, in one or more devices (e.g., processor, chip, computer, tablet, mobile device).

While not explicitly described or illustrated herein, it will be appreciated that the maritime vehicle 100 includes several additional components. For example, the maritime vehicle 100 includes various sealing elements configured to provide seals between different components of the vehicle 100 (or between the vehicle 100 and the environment surrounding the vehicle 100). As another example, the maritime vehicle 100 also includes various fasteners that help to couple the components of the maritime vehicle 100 together. As yet another example, the maritime vehicle 100 includes cabling that helps to communicatively couple components of the maritime vehicle 100 together. As yet another example, the maritime vehicle 100 includes various electrical components that help to operate the maritime vehicle 100, e.g., one or more relay boards, one or more DC-DC converters, one or more supervisor boards, and/or one or more brain boards.

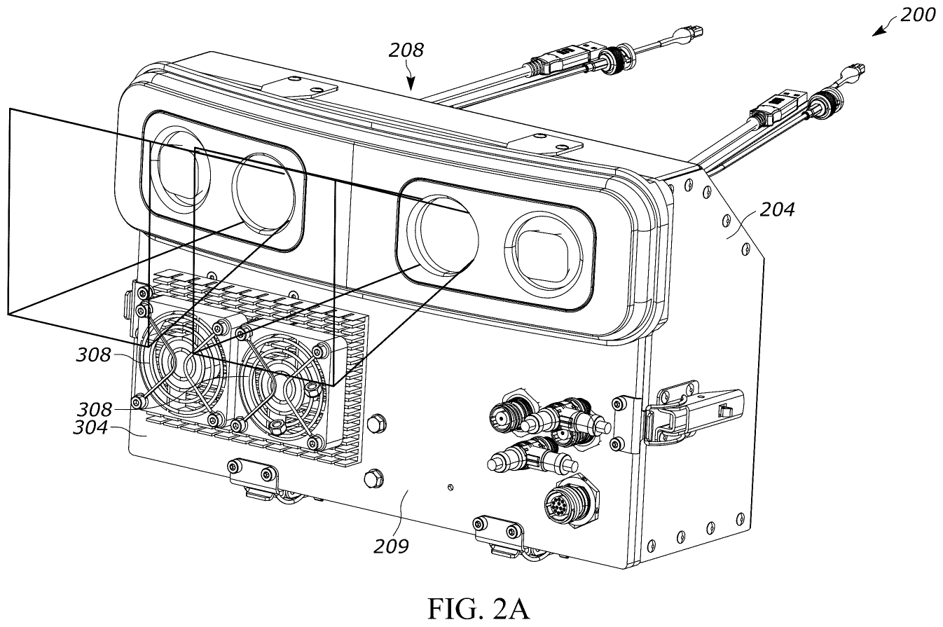

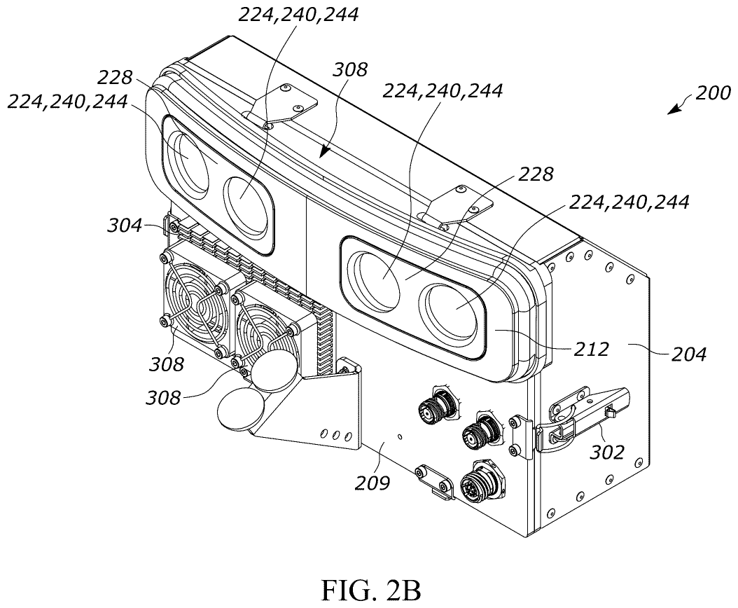

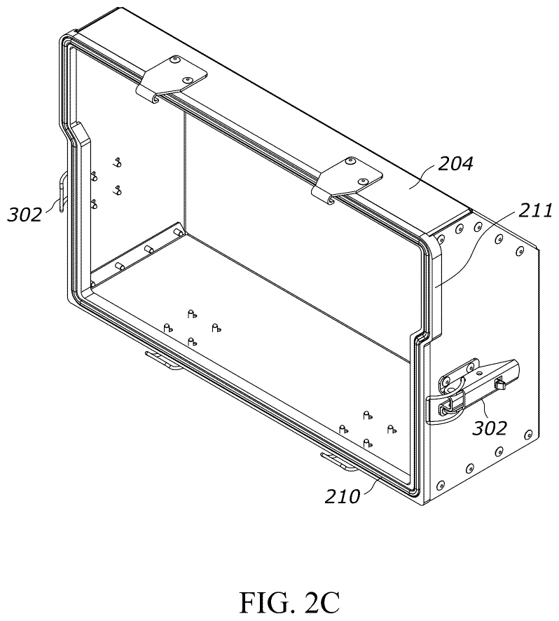

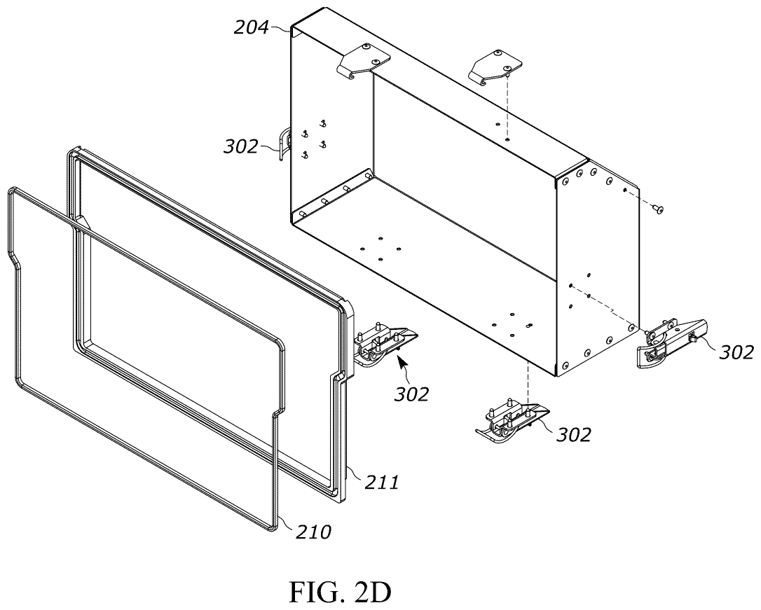

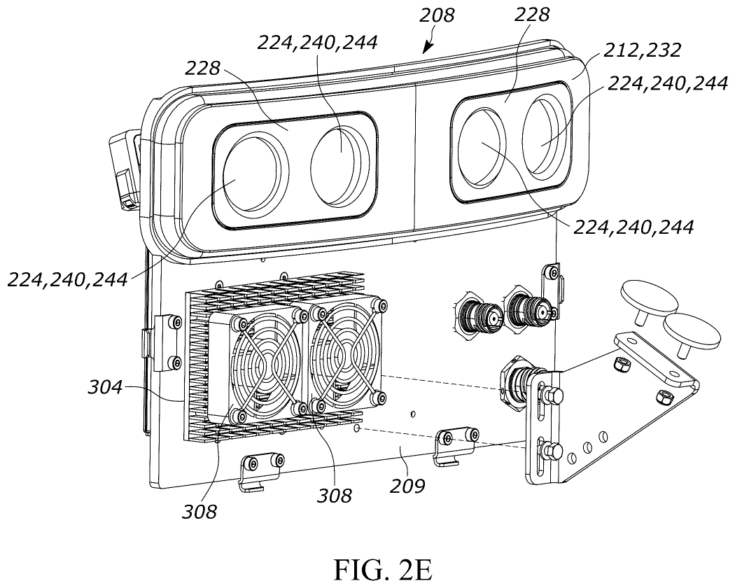

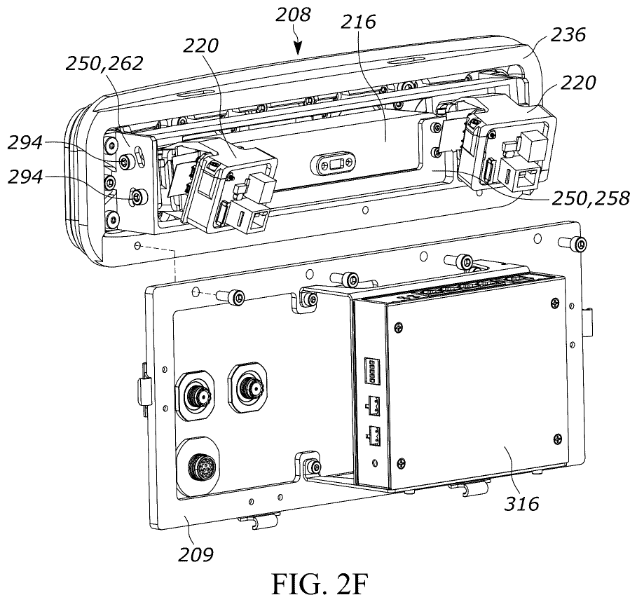

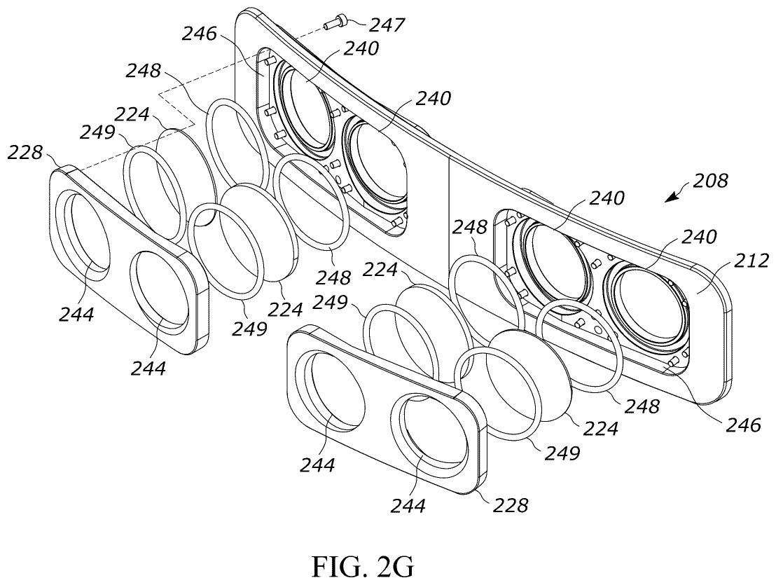

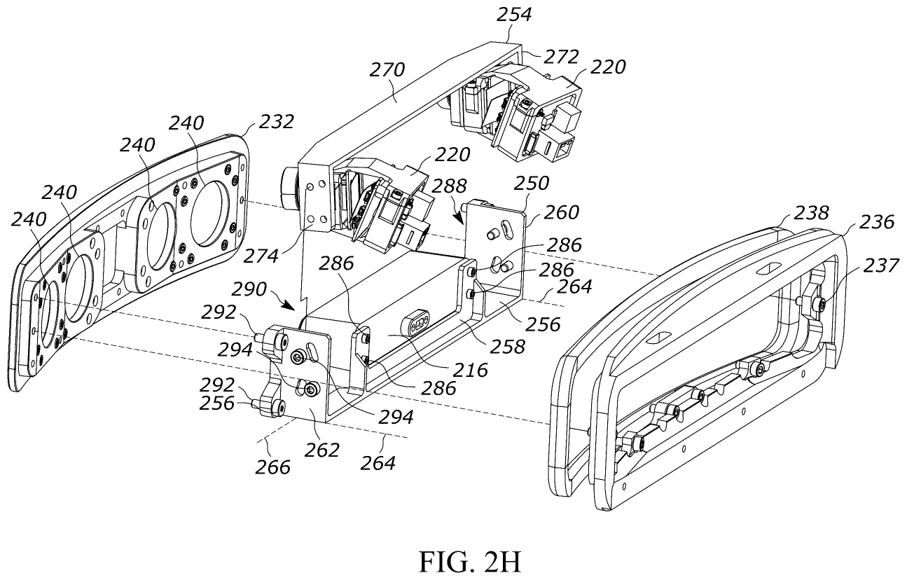

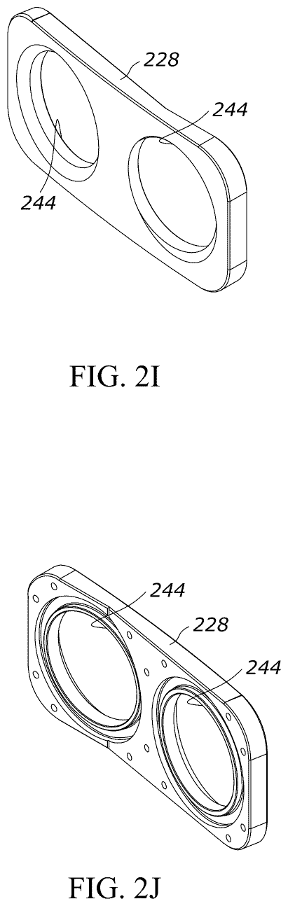

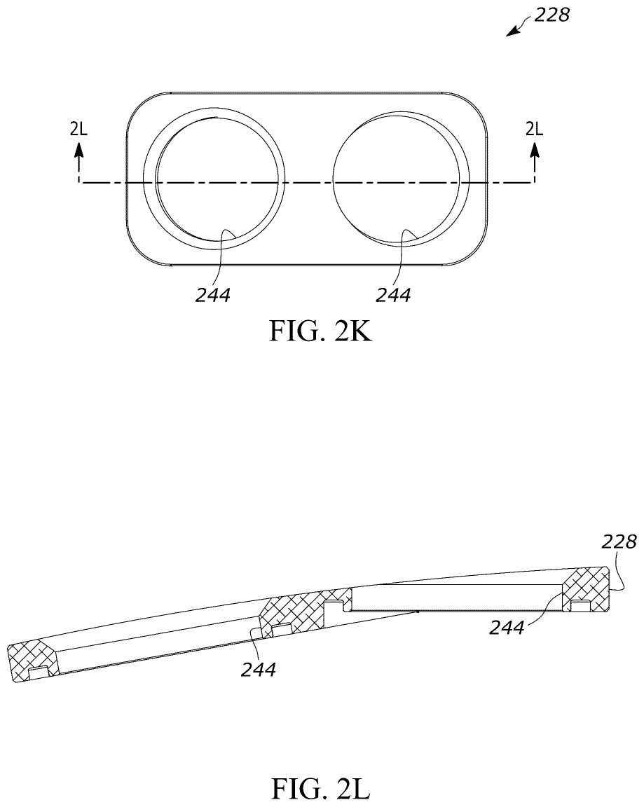

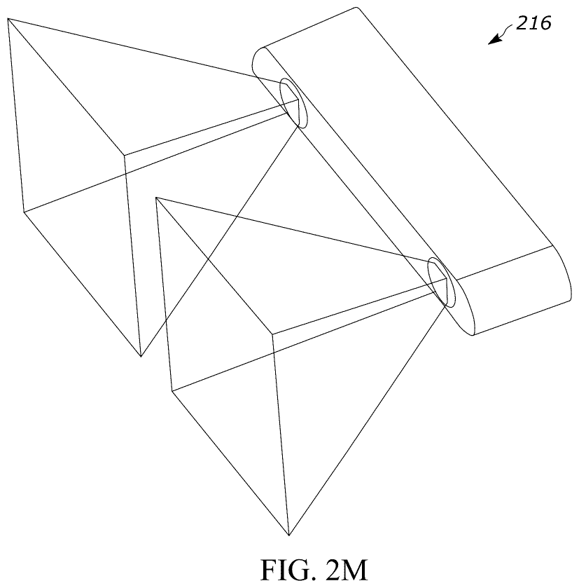

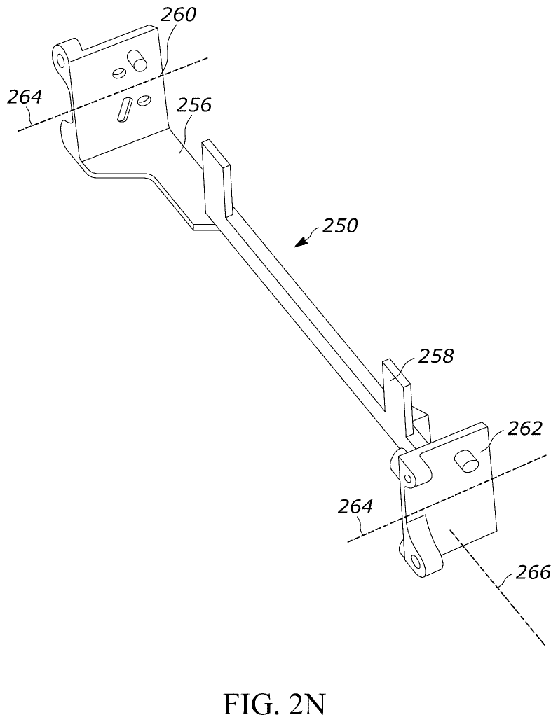

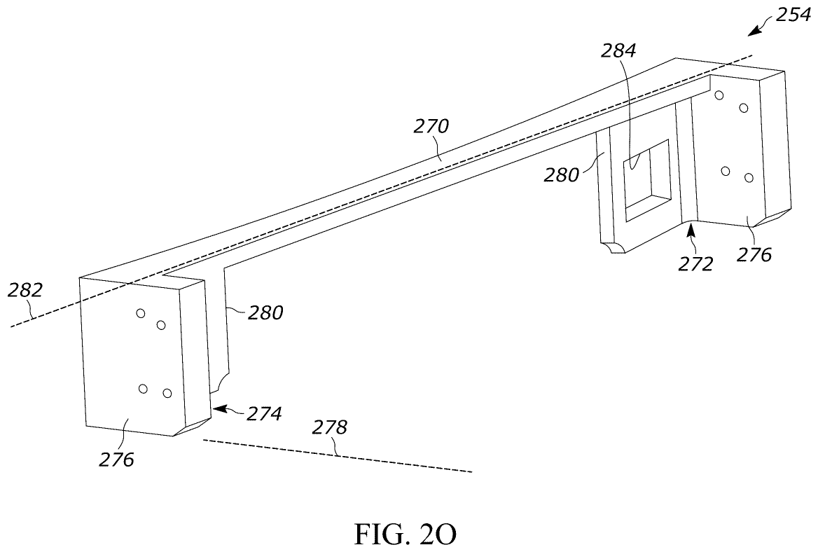

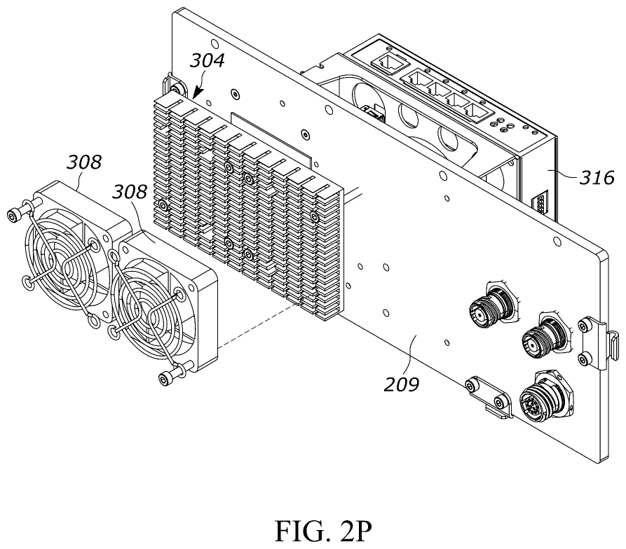

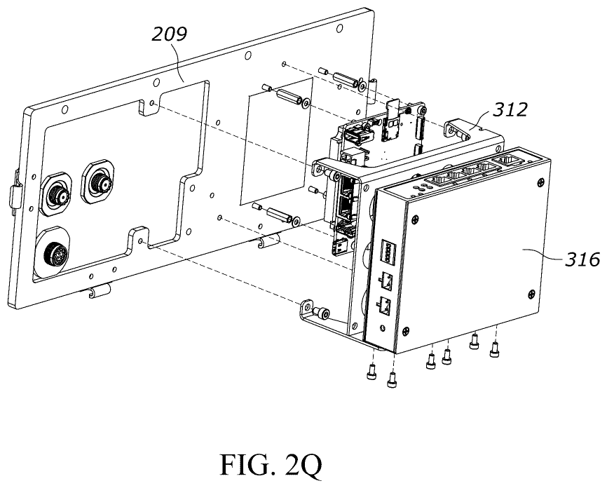

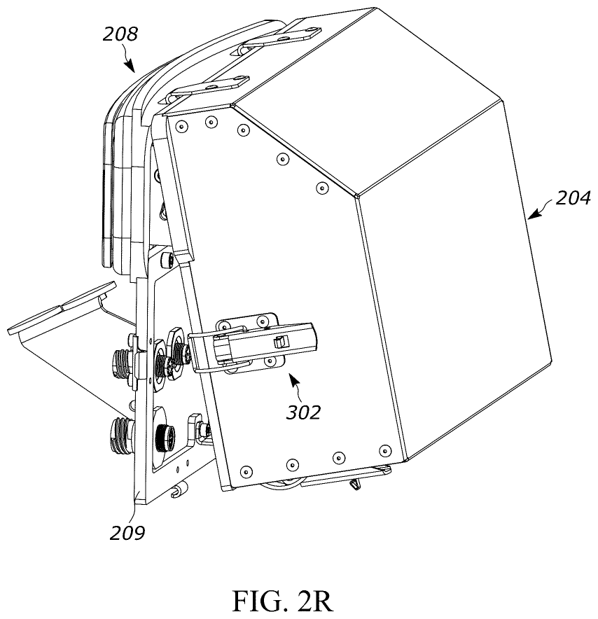

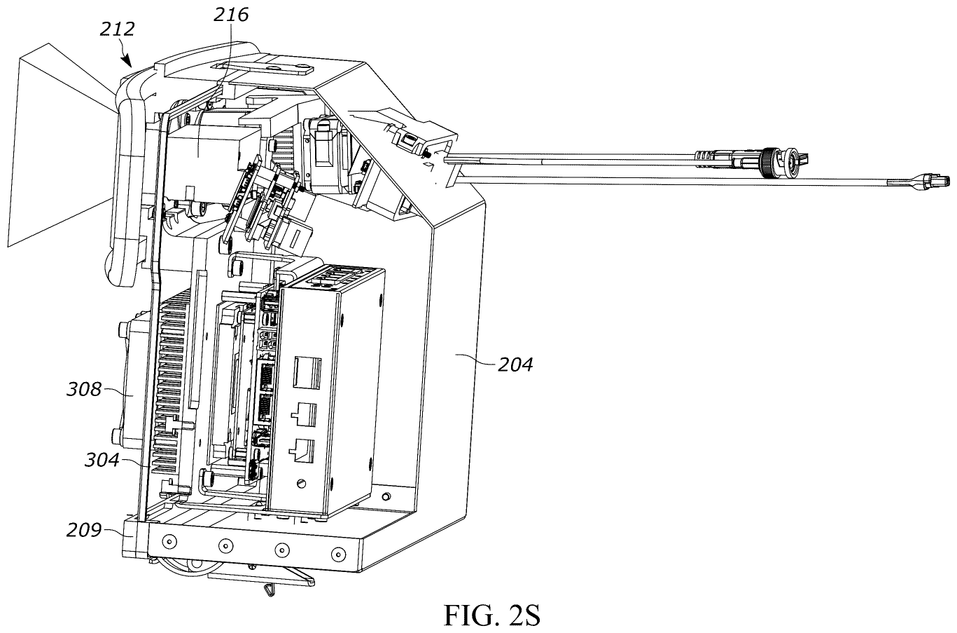

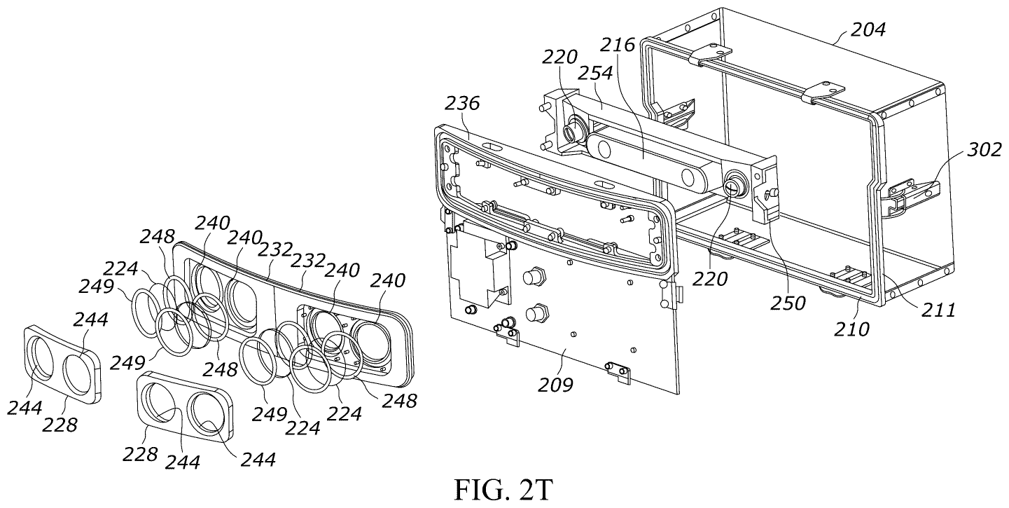

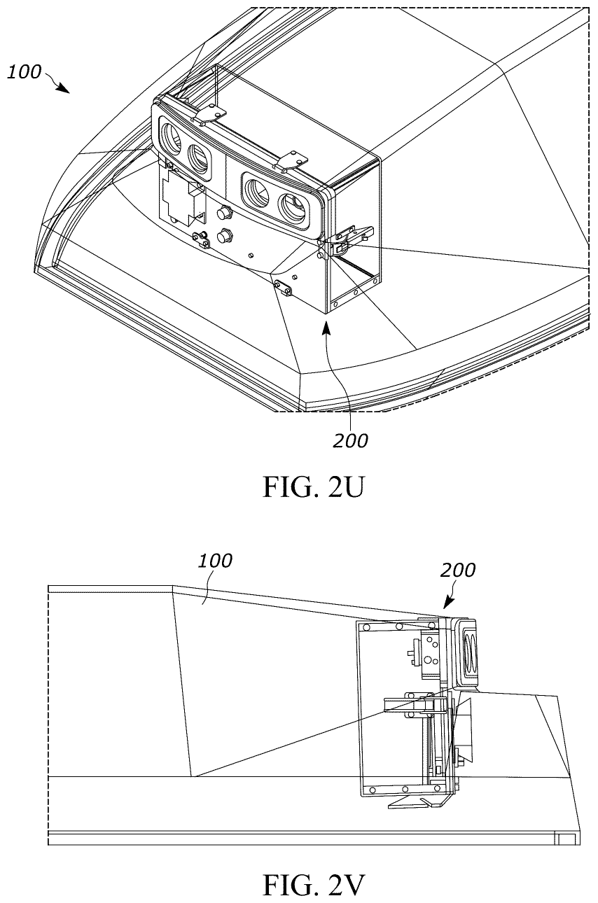

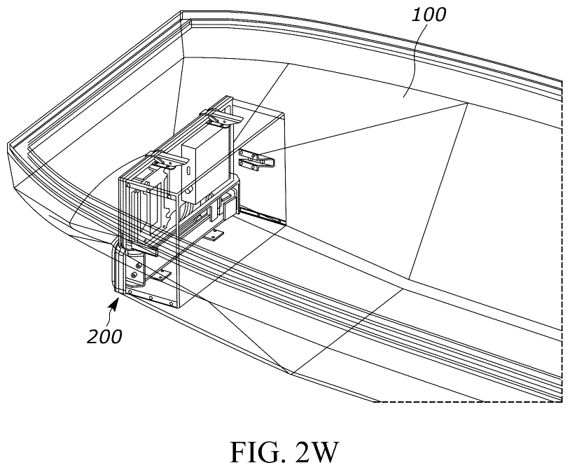

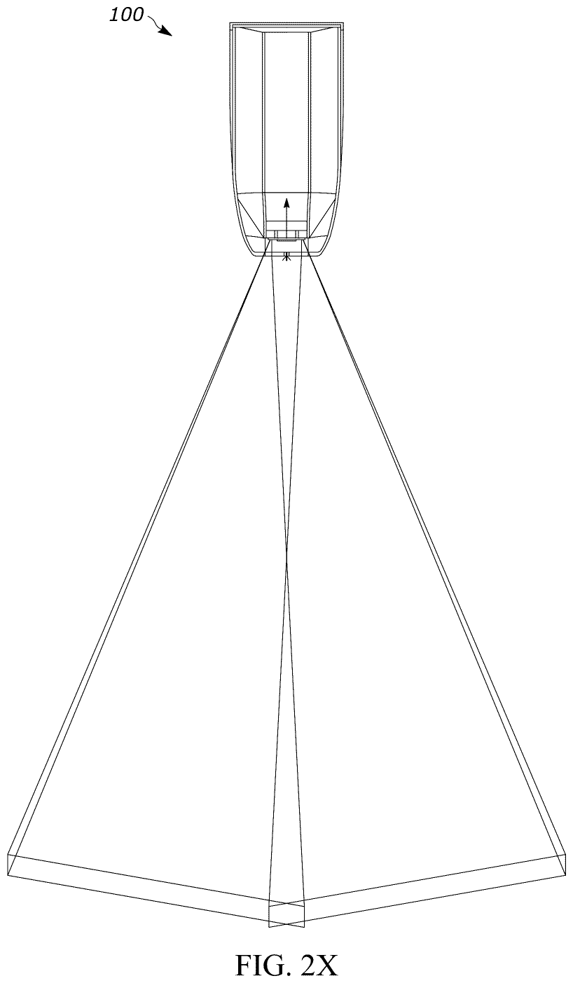

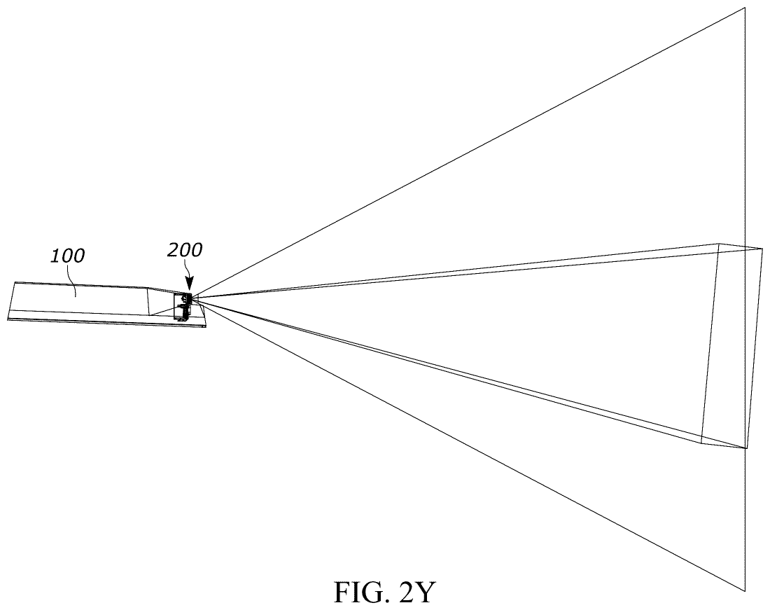

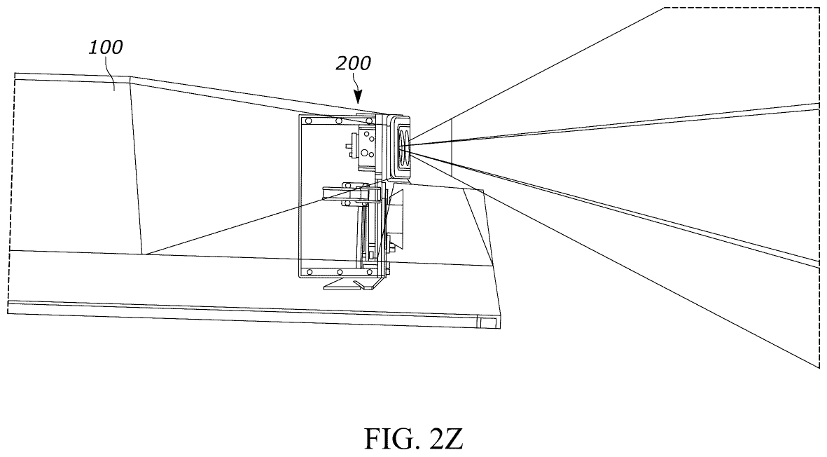

FIGS. 2A-2Z illustrate further details regarding the vision system 200 that can be employed in the maritime vehicle 100. In this example, the vision system 200 is a stereoscopic vision unit that includes two independent stereoscopic cameras and is mounted to a front of the maritime vehicle 100. The vision system 200 can, for example, be sealingly and securely mounted to a front of the hull cap 108 (see, for example, FIGS. 1A and 1K). Accordingly, the vision system 200 is optimally positioned to capture, process, and analyze data about the environment surrounding the maritime vehicle 100. Broadly speaking, the vision system 200 is configured to passively detect or sense the presence and/or absence of an object (and/or of any objects, for that matter) within the FOV of the vision system 200 and enable accurate depth (i.e., distance) estimates of such objects using stereoscopic techniques.

The vision system 200 generally includes a housing 204, a camera module 208 coupled to and carried by the housing 204, and an electronics plate 209 coupled to and carried by the housing 204. The housing 204 is configured to be mounted to the maritime vehicle 100, and, more particularly, to the hull cap 108 (see FIGS. 1A and 1K). The housing 204 is preferably made of aluminum or fiberglass but can be made of another strong material such that the housing 204 protects the camera module 208 when the maritime vehicle 100 experiences significant shock (e.g., shock values up to 20G), traverses the body of water at high speeds, or is used in dangerous conditions. Preferably, and as best illustrated in FIGS. 2C, 2D, and 2T, the vision system 200 also includes a first sealing element (e.g., a gasket) 210 and a mount 211 for mounting the first sealing element 210 to the housing 204. In this example, the mount 211 has a substantially rectangular shape and is coupled (e.g., fixedly or removably coupled) to an outer perimeter edge of the housing 204, and the first sealing element 210 has a similar shape as the mount 211 and is removably disposed in a channel formed in the mount 211. When the first sealing element 210 is mounted to the housing 204 via the mount 211, the first sealing element 210 surrounds the interior of the housing 204, such that the first sealing element 210 is arranged to sealingly engage the camera module 208 and the electronics plate 209 and to effect a seal between the housing 204 and the camera module 208 and the electronics plate 209 when the camera module 208 and the electronics plate 209 are coupled to the housing 204. In other words, the first sealing element 210 serves to seal the electrical components within an interior of the housing 204 when the camera module 208 and the electronics plate 209 are coupled to the housing 204.

The camera module 208 generally includes a frame 212, one or more electro-optical (EO) cameras 216, one or more infrared (IR) cameras 220, a plurality of windows (or lenses) 224, and a plurality of window retention plates 228 for the windows 224. In this example, the frame 212 is defined by a face plate 232 and a cap 236 coupled to the face plate 232 via a plurality of fasteners 237 (one of which is illustrated in FIG. 2H) and via adhesive (e.g., applied to the rear surface of the face plate 232). In other examples, the face plate 232 and the cap 236 can be coupled together in a different manner. Preferably, the frame 212 also includes a sealing element 238 (e.g., a gasket) secured to the cap 236 so as to be disposed between the face plate 232 and the cap 236. In this example, the sealing element 238 is secured in a groove formed in the front surface of the cap 236. The frame 212 also includes a plurality of openings 240 formed in the face plate 232 and sized to receive the windows 224. In this example, the frame 212 includes four openings 240 divided into two pairs of openings. In other examples, however, the frame 212 can include more or fewer openings 240. Further, while not illustrated herein, it will be appreciated that the camera module 208 also generally includes a plurality of covers configured to selectively cover the plurality of windows 224, respectively. The plurality of covers may also cover the plurality of apertures 244 formed in the window retention plates 228.

In this example, the camera module 208 includes a single electro-optical camera 216 that preferably takes the form of a stereo camera with dual EO image sensors. In this example, the camera module 208 includes two infrared cameras 220. Each of the infrared cameras 220 preferably takes the form of a stereovision IR camera, which may utilize one or more of short-wave IR (SWIR), mid-wave IR (MWIR) (cooled or uncooled), and/or long-wave IR (LWIR) (cooled or uncooled) sensors. When the camera module 208 includes pairs of EO/IR cameras 216, 220, each camera may be configured to capture similar electromagnetic radiation across a similar FOV, and may be separated (e.g., fixedly separated) by a baseline distance.

In this example, because the frame 212 includes four openings 240, the camera module 208 includes four windows 224. In this example, each window of the plurality of windows 224 is flat. In this example, each of the windows 224 has an anti-reflective coating. Preferably, the windows positioned in front of the EO camera 216 are comprised of a substance that is translucent to visible light, and the windows positioned in front of the IR cameras 220 are comprised of a substance that is transparent to one or more IR wavelengths. For example, at least two windows of the plurality of windows 224 may be germanium windows (e.g., manufactured by Edmund Optics). In this example, the camera module 208 includes two window retention plates 228, one window retention plate 228 for each of the pairs of openings 240. Thus, in this example, each of the two retention plates 228 has a pair of apertures 244, each aperture 244 sized and arranged to be aligned with a corresponding one of the openings 240 and a corresponding one of the windows 224 when the two retention plates 228 are coupled to the frame 212. In this example, each of the two retention plates 228 is coupled to the frame 212 by disposing each of the retention plates 228 in one of the mounting cavities 246 formed in the frame 212 and inserting a plurality of fasteners 247 (only one of which is shown in FIG. 2G) through the frame 212 and the respective retention plate 228.

In this example, and as best illustrated in FIGS. 2I-2L, the frame 212 has an outer surface that is curved, creating the appearance that the windows 224 are curved as well (even though they are flat). In this example, each window retention plate 228 has an outer surface that is also curved and is flush with the outer surface of the frame 212. Further, as best illustrated in FIG. 2G, it will be appreciated that the camera module 208 may also include a plurality of third scaling elements 248 and a plurality of fourth sealing elements 249. The third sealing elements 248, which in this example take the form of O-rings, are seated in a channel formed in the frame 212 at a position surrounding the openings 240, respectively. In turn, the third sealing elements 248 are disposed so as to sealingly engage the rear surface of the windows 224, respectively. Meanwhile, the fourth sealing elements 249 in this example also take the form of O-rings but are seated in a channel formed in one of the window retention plates 228 at a position surrounding a corresponding one of the apertures 244. In turn, the fourth sealing elements 249 are disposed so as to sealingly engage the front surface of the windows 224, respectively.

The camera module 208 also generally includes an EO bracket 250 and an IR bracket 254. As best illustrated in FIGS. 2H and 2N, the EO bracket 250 in this example has a base 256, a camera support 258, a first wall 260, and a second wall 262. The camera support 258 is coupled to and extends outward (upward in FIGS. 2H and 2N) from a central portion of the base 256. As such, the camera support 258 is positioned to receive and support the EO camera 216. The first wall 260 is coupled to and extends outward (upward in FIGS. 2H and 2N) from a first end of the base 256, whereas the second wall 262 is coupled to and extends outward (upward in FIGS. 2H and 2N) from a second end of the base 256. In turn, the second wall 262 is disposed opposite and faces the first wall 260, and each of the first and second walls 260, 262 is oriented along a respective longitudinal axis 264 perpendicular to a transverse axis 266 along which the base 256 is oriented.

Meanwhile, as best illustrated in FIGS. 2H and 2O, the IR bracket 254 in this example has a base 270, a first camera support 272, and a second camera support 274. The first camera support 272 is generally configured to receive and support one of the IR cameras 220, whereas the second camera support 272 is generally configured to receive and support the other IR camera 220. More particularly, the first camera support 272 is coupled to a first end of the base 270, whereas the second camera support 272 is coupled to a second end of the base 270 opposite the first camera support 272. Each of the first and second camera supports 272, 274 is defined by a pair of walls, a first wall 276 that is oriented along a respective longitudinal axis 278 and a second wall 280 that is, like the base 270, oriented along a transverse axis 282 that is perpendicular to the longitudinal axes 278. As best illustrated in FIG. 2O, the IR bracket 254 in this example also includes a pair of openings 284, one in each of the second walls 280, sized to receive and retain a respective one of the IR cameras 220 therein.

Turning now to FIGS. 2F, 2H, and 2T, the EO camera 216 is coupled to the EO bracket 250 via fasteners 286 disposed in the camera support 258 and the rear side of the EO camera 216. In turn, the EO camera 216 is centrally located in the EO bracket 250, with a first cavity 288 defined between the EO camera 216 and the first wall 260 and a second cavity 290 defined between the EO camera 216 and the second wall 262. The EO bracket 250 is also coupled to the frame 212 so as to retain the EO camera 216 in position immediately adjacent two of the openings 240. More particularly, in this example, the EO bracket 250 is coupled to the face plate 232 via a plurality of fasteners 292 carried by an outer portion of the EO bracket 250 and inserted into apertures formed in the rear surface of the face plate 232. In other examples, however, the EO bracket 250 can be coupled to the face plate 232 and/or the cap 236 in a different manner.

With reference still to FIGS. 2F, 2H, and 2T, the IR cameras 220 are coupled to the IR bracket 254 such that the IR cameras 220 are carried by and extend outward (downward in FIGS. 2F, 2H, and 2T) from the base 270. In this example, the IR cameras 220 are coupled to the IR bracket 254 by way of the openings 284, through which the IR cameras respectively extend, and a plurality of fasteners (not shown) inserted into a retaining ring (not shown) and apertures formed in the second walls 280 (see FIG. 2O). In turn, the IR cameras 220 are located at the first and second ends of the base 270.

As also illustrated in FIGS. 2F, 2H, and 2T, the IR bracket 254 is coupled to the EO bracket 250 such that the IR cameras 220 are coupled to the EO camera 216 in a single unit. In this example, the IR bracket 254 is coupled to the EO bracket 250 by disposing the first and second camera supports 272, 274 in the first and second cavities 288, 290, respectively, and inserting a plurality of fasteners 294 (see FIG. 2H) into a plurality of apertures respectively formed in each of the first walls 276. In turn, the IR bracket 254 is partially disposed in the EO bracket 250, and the IR cameras 220 are disposed in the first and second cavities 288, 290, with the IR cameras 220 substantially horizontally aligned with the EO camera 260 and one IR camera 220 on each side of the EO camera 216, as best illustrated in FIG. 2T. Moreover, the axes 264, 278 will be parallel (or substantially parallel) and the axes 266, 282 will be parallel (or substantially parallel). Further, by virtue of being coupled to the EO bracket 250, the IR bracket 254 is also coupled to the frame 212 but is configured to retain the IR cameras 220 in position immediately adjacent the other two openings 240. As referenced herein, objects (e.g., cameras, sensors) may be immediately adjacent to other objects (e.g., openings) without directly contacting them. For example, a sensor is immediately adjacent to an opening when the edges of the opening do not obscure the FOV of the sensor.

As discussed above, the vision system 200 also includes the electronics plate 209, which is coupled to both the housing 204 and the camera module 208. In this example, the electronics plate 209 is removably coupled to the housing 204 via a plurality of latches 302. In other examples, however, the electronics plate 209 can be removably coupled to the housing 204 in a different manner or can be permanently coupled (e.g., welded) to the housing 204. The electronics plate 209 includes various electrical components for the camera module 208, including, for example, a heat sink 304 for dissipating heat generated by the electrical components of the vision system 200 (e.g., the camera 216 and/or the cameras 220), one or more fans 308 arranged to direct air into the heat sink 304, an autonomous computer 312, and a communication module 316. The electronics plate 209 can include other electrical or mechanical components as well.

When the camera module 208 is coupled to the housing 204, it will be appreciated that the baseline distance between pairs of the dual EO image sensors and the EO/IR cameras 216, 220 is well-toleranced and is maximized as much as possible. In turn, the delta is consistent and the vision system 200 enables downstream ranging. When the maritime vehicle 100 is in use, and the vision system 200 is operational, the vision system 200 can, for example, have the FOV illustrated in FIGS. 2X-2Z.

The vision system 200 described herein may utilize passive sensing technology (e.g., cameras that do not actively emit radiation). Additionally, or alternatively, the vision system 200 may also include an active sensing system, such as a RADAR (Radio Detection and Ranging), LIDAR (Light Detection and Ranging), and/or some other type of active sensing system which generally requires the active sensing system to expressly or actively initiate transmissions of signals (e.g., radio signals, light signals, sound signals, etc.) to perform the sensing of remote objects. However, an active sensing system is not a necessary or required component of the AMSV. Indeed, in some examples, the maritime vehicle 100 does not include (that is, the maritime vehicle 100 excludes) any type of active sensing system at all. In some examples, the maritime vehicle 100 includes an active sensing system but powers down, deactivates, disables, or turns off the active sensing system altogether (e.g., so that that active sensing system does not emit any signals and transmissions at all, including not transmitting any heartbeat, scanning, or other administrative types of signals) so that the maritime vehicle 100 is totally “radio-silent” and relies only on passive sensing data provided by the passive components (e.g., IR cameras 220) of the vision system 200 to detect/identify objects, generate control signals, and/or perform any other suitable functions.

While the vision system 200 is shown and described in connection with the maritime vehicle 100, the vision system 200 can be employed in a different maritime vehicle (e.g., a boat, watercraft, submarine, or amphibious vehicle) that is intended for military purposes (e.g., for naval defense, patrolling waters and enforcing laws, reconnaissance, naval exploration, monitoring) or other purposes (e.g., for commercial use, for recreational use). The vision system 200 can also be employed in a different type of vehicle (e.g., a car, a truck, a train), a manipulative robot (e.g., surgical robots, drones), or any other device or system that could benefit from a calibrated vision system. The vehicle employing the vision system 200 can be manned (i.e., operated by an onboard human) or unmanned, and unmanned vehicles can be remotely controlled or autonomous, for example.

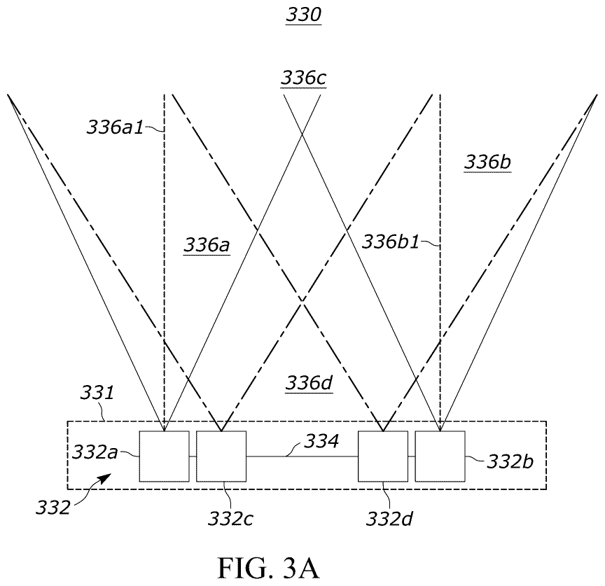

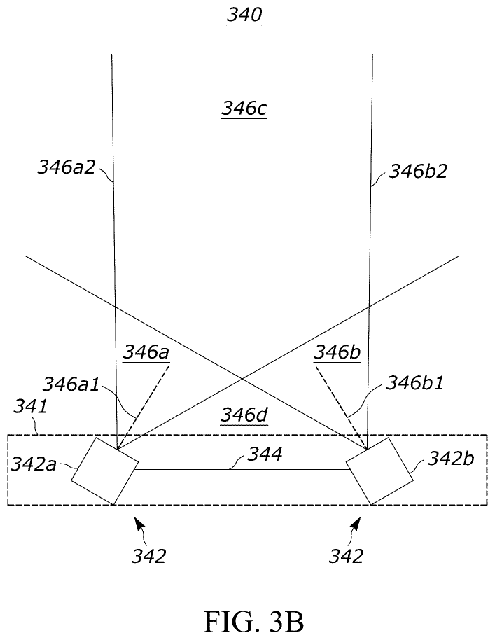

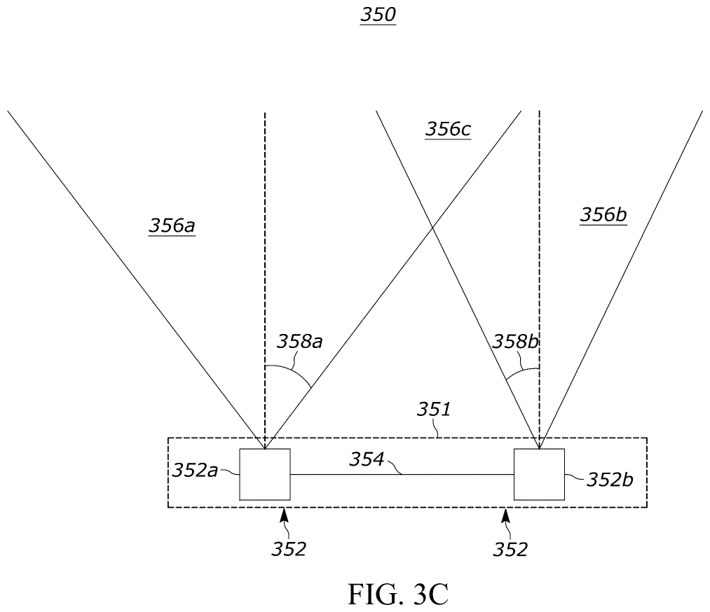

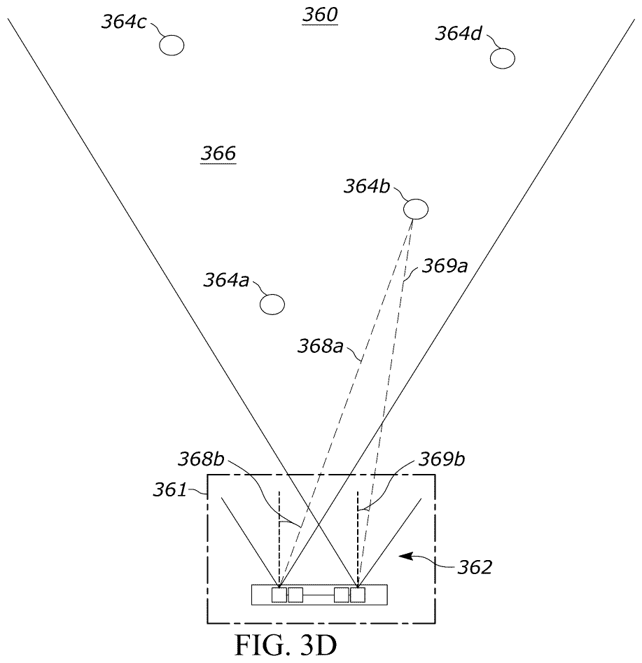

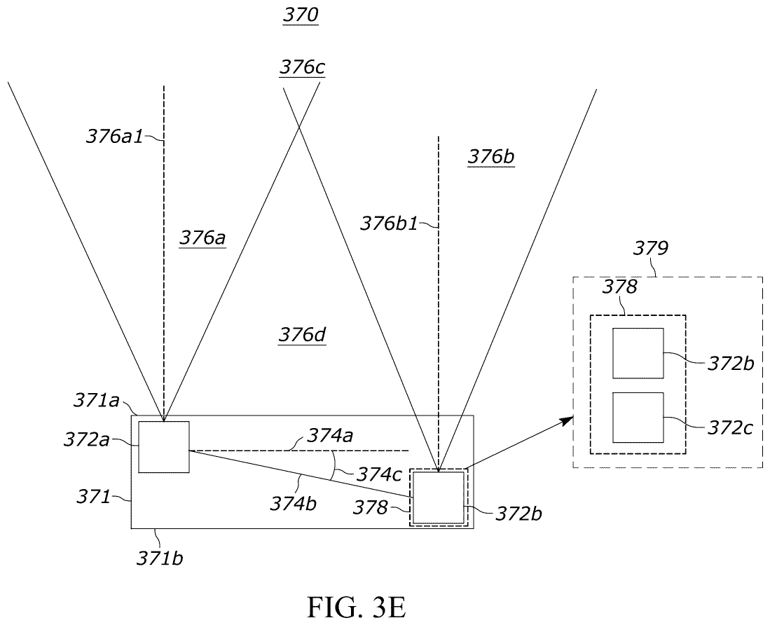

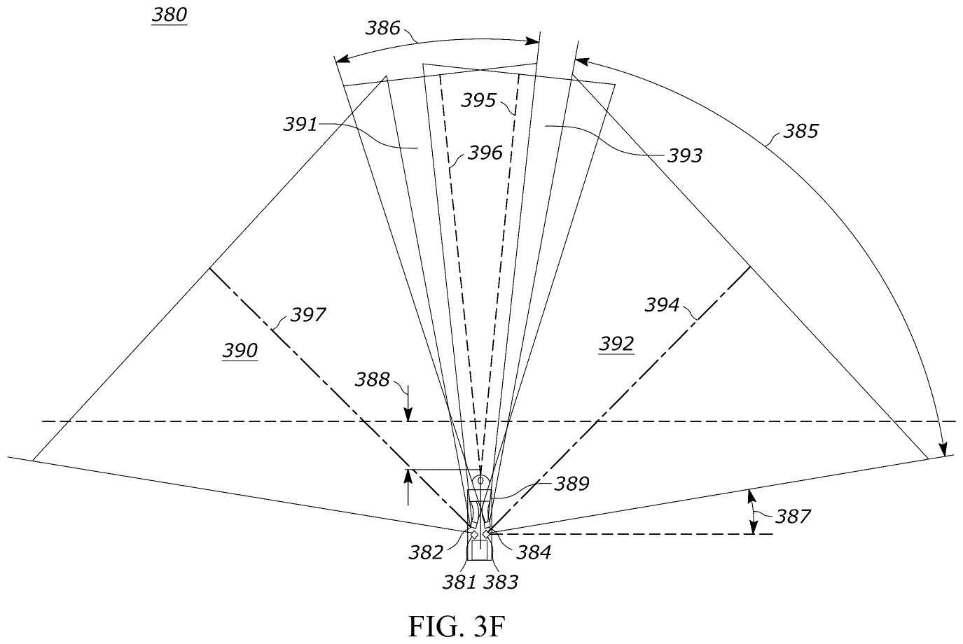

Additionally, or alternatively, the vision system 200 may have a variety of FOVs, resulting from different hardware configurations. To further explain several of these configurations of the vision system 200, and the FOVs and implications arising therefrom, FIGS. 3A-3F depict examples of different perception hardware configurations for the vision system 200. For example, FIG. 3A depicts a first example perception hardware configuration 330, in accordance with the teachings of the present disclosure. It should be appreciated that the configurations illustrated and described in reference to FIGS. 3A-3F may be, include, and/or otherwise utilize some/all of the components described herein in reference to FIGS. 1A-2Z.

Generally, the first example perception hardware configuration 330 includes a frame 331 that is similar to the frame 212 and houses or carries two stereovision cameras 332 configured to capture radiation from an external environment of the maritime vehicle 100 (or other vehicle or system/device), upon which, the first example perception hardware configuration 330 is mounted, integrated, and/or otherwise associated. In particular, the two stereovision cameras 332 are configured to capture radiation using two pairs of image sensors 332a/b, 332c/d separated by a baseline distance 334 that mimics human binocular vision and thereby enables depth perception based on the feature disparities within the captured images.

The two stereovision cameras 332 include an IR stereovision camera comprised of a first IR image sensor 332a and a second IR image sensor 332b and an electro-optical (EO) stereovision camera comprised of a first EO image sensor 332c and a second EO image sensor 332d. At least the IR stereovision camera passively captures (e.g., does not include/use an emission source) radiation, but it should be appreciated that any of the perception systems described herein may utilize passive sensing and/or active sensing. Moreover, while the discussion herein focuses primarily on the IR stereovision camera, the descriptions of the IR stereovision camera and corresponding IR image sensors may apply to the EO stereovision cameras, EO image sensors, and/or other sensing systems described herein.

For example, the hardware configurations described herein may include at least one monochrome image sensor and at least one multi-color sensor, and in some examples, the monochrome image sensor has a wider FOV than the multi-color sensor, or vice versa. Generally, removing color filters from a typical color sensor increases the total incident light by up to approximately a factor of five, which significantly improves the imaging resolution, especially at distance and in lower light conditions. Moreover, the techniques of the present disclosure may partially recover chroma information by superimposing the information from other sensors, including lower resolution sensors.

Additionally, it should be appreciated that the FOVs, blind spots, and/or objects depicted in FIGS. 3A-3F are not necessarily drawn to scale relative to the stercovision components (e.g., IR image sensors) also depicted in FIGS. 3A-3F. Thus, in practical implementations, the FOVs, blind spots, and/or objects may extend beyond or have dimensions greater than the dimensions/scale depicted in FIGS. 3A-3F.

As illustrated in FIG. 3A, the first IR image sensor 332a and the second IR image sensor 332b have FOVs 336a, 336b, represented by the lines extending diagonally outwards from the first and second IR image sensors 332a, 332b. Both IR image sensor FOVs 336a, 336b have an optical axis 336a1, 336bl that corresponds to the principal point of the FOVs 336a, 336b at any distance from the image sensors 332a, 332b. Thus, any object located in the external environment in-line with either optical axis 336a1, 336bl will appear at the principal point of the resulting image created by the respective image sensor(s) 332a, 332b.

These two FOVs 336a, 336b intersect/overlap at a particular distance away from the image sensors 332a, 332b, creating a composite FOV 336c and a blind spot 336d. For example, the two FOVs 336a, 336b may overlap at a distance of less than approximately 10 meters from a front surface of the maritime vehicle 100 (or a front surface of the frame 371 or the image sensors 332a, 332b). The composite FOV 336c represents a physical region of the external environment, from which, both image sensors 332a, 332b capture radiation, and consequently capture representations of the same objects/features within the external environment. However, because the composite FOV 336c includes different portions of the individual image sensor 332a, 332b FOVs 336a, 336b, the same object/feature representations in the images are included at different positions within the images. For example, in simultaneous image captures of the first IR image sensor 332a and the second IR image sensor 332b, a target vessel located within the composite FOV 336c will generally appear more towards the right edge of the first FOV 336a than the target vessel will appear relative to the right edge of the second FOV 336b because the optical axes 336a1, 336b1 are parallel.

The blind spot 336d is a region of the external environment that is imperceptible by the IR stereovision camera because the IR image sensors 332a, 332b are not oriented and/or the focusing optics are otherwise not configured to capture radiation from this region. It will be appreciated that the FOVs 336a-c and the blind spot 336d in FIG. 3A are not drawn to scale, such that the blind spot 336d may only comprise a relatively small portion of the external environment, as compared to the portions included/covered by the FOVs 336a-c. Nevertheless, the blind spot 336d may preclude or complicate the sensing/perception systems described herein from accurately detecting, identifying, and/or otherwise locating objects disposed within this relatively small region proximate to the maritime vehicle 100 (or other system/device employing the vision system 200). This can lead to issues when the maritime vehicle 100 needs to maneuver precisely relative to objects located within the blind spot 336d, such as when an AMSV path plan involves the maritime vehicle 100 contacting or otherwise maneuvering into very close proximity to a tracked object (e.g., a target vessel).

To overcome these potential issues, FIG. 3B depicts a second example perception hardware configuration 340, in accordance with the teachings of the present disclosure. The second example perception hardware configuration 340 includes a frame 341 that is similar to the frame 212 and houses or carries an IR stereovision camera 342 that includes a first IR image sensor 342a and a second IR image sensor 342b separated by a baseline distance 344. The first IR image sensor 342a has a first FOV 346a and the second IR image sensor 342b has a second FOV 346b and the image sensors 342a, 342b are oriented slightly towards one another. As a result, and unlike the optical axes 336a1, 336bl of FIG. 3A, the first optical axis 346al of the first FOV 346a is not parallel with the second optical axis 346bl of the second FOV 346b.

More specifically, the first IR image sensor 342a and the second IR image sensor 342b are oriented towards one another such that a left edge 346a2 of the first FOV 346a is substantially parallel (e.g., within 5° of exactly parallel) to a right edge 346b2 of the second FOV 346b. This configuration of the first IR image sensor 342a and the second IR image sensor 342b yields a central FOV 346c that includes more of the external environment that was previously included as part of the blind spot 336d of FIG. 3A. Thus, the blind spot 346d is significantly smaller than the blind spot 336d and thereby enables the sensing/perception systems described herein to detect, identify, and/or otherwise locate objects disposed proximate to the maritime vehicle 100 to more accurately than in the first example perception hardware configuration 330. In some examples, the first IR image sensor 342a and the second IR image sensor 342b may be oriented towards one another, but the left edge 346a2 and the right edge 346b2 may not be substantially parallel.

Further, the first IR image sensor 342a and the second IR image sensor 342b may be physically oriented towards one another and/or may include optical components that yield the FOVs 346a, 346b illustrated in FIG. 3B. For example, the first IR image sensor 342a and the second IR image sensor 342b may include various optical components (e.g., windows, mirrors, prisms, gratings, etc.) configured to focus, reflect, diffract, and/or otherwise manipulate the incoming radiation that may consequently impact the FOVs 346a, 346b. In this configuration 340, any objects within the central FOV 346c will move to the opposite side of the image sensor 342a, 342b from what is intuitively expected. Namely, objects positioned in the central FOV 346c (e.g., at distances greater than a few meters from the IR stereovision camera 342) will be on the left side of the optical axis 346al and on the right side of the optical axis 346b1.

It should be appreciated that the angular size of the overlap illustrated in FIG. 3B decreases significantly with distance, but stereovision accuracy also becomes significantly less accurate with distance. Thus, the angular alignment of the two image sensors 342a, 342b should be chosen to optimize the total angle of both FOVs 346a, 346b (e.g., the union of FOVs 346a, 346b) and the distance at which the overlap angle becomes too small. Orienting the image sensors 342a, 342b inward past where the edges 346a2, 346b2 are substantially parallel will create an FOV overlap of finite size.

In certain embodiments, the imagers 342a, 342b may be faced in opposite directions (e.g., outward), which will decrease the FOV overlap (e.g., size of central FOV 346c) and increase the size of the union of the FOVs 346a, 346b. However, turning the imagers 342a, 342b outward will necessarily create a larger blind spot than the blind spot 346d illustrated in FIG. 3B, such that the systems described herein may lack data of objects proximate to the maritime vehicle 100 (or other system/vehicle employing the vision system 200).

In certain instances, the maritime vehicle 100 may benefit from expanding or narrowing the FOVs of the perception system. For example, a wider FOV enables more robust object tracking within the FOV at least by reducing the likelihood of the object slipping outside of the FOV edges and therefore exceeding the perceptive range of the maritime vehicle 100. A narrower FOV can increase the accuracy of object detection/identification/tracking by increasing the effective image resolution as a direct result of increasing the pixel density in the observed angular region. FIG. 3C depicts a third example perception hardware configuration 350 that leverages wider/narrower FOVs, in accordance with the teachings of the present disclosure.

The third example perception hardware configuration 350 includes a frame 351 that is similar to the frame 212 and carries or houses an IR stereovision camera 352 with a first IR image sensor 352a and a second IR image sensor 352b separated by a baseline distance 354. The first IR image sensor 352a has a relatively wide FOV 356a, as indicated by the first angle 358a. The second IR image sensor 352b has a relatively narrow FOV 356b, as indicated by the second angle 358b. In particular, the first angle 358a is greater than the second angle 358b, and results in a wider FOV 356a than the FOV 356b, as well as the FOVs 336a, 336b, 346a, and 346b illustrated in FIGS. 3A and 3B. By contrast, the second angle 358b results in a narrower FOV 356b than the FOV 356a, as well as the FOVs 336a, 336b, 346a, and 346b illustrated in FIGS. 3A and 3B.

Using this third example perception hardware configuration 350, the perception systems described herein may detect/identify/track objects located within the composite FOV 356c more accurately based on the narrow FOV 356b and/or may achieve more robust tracking capabilities due to the larger overall FOV from the wide(r) FOV 356a. Namely, the narrow FOV 356b achieves a higher angular pixel density for objects detected within the composite FOV 356c, and the wide FOV 356a may achieve a larger overall FOV (e.g., FOV 356a combined with FOV 356b) to ensure tracked objects do not fall outside of the FOV edges.

Of course, the example configuration 350 represented in FIG. 3C is for the purposes of discussion only, and it should be appreciated that any combination of image sensors with narrower/wider FOVs and/or orientations of image sensors or optics (e.g., windows, etc.) may be utilized to achieve the desired advantages. For example, a first combination may include an image sensor (e.g., 352b) with the narrow FOV 356b and an image sensor with any of the other FOVs (336a, 336b, 346a, 346b) illustrated and described herein. A second example combination may include an image sensor (e.g., 352a) with the wide FOV 356a and an image sensor with any of the other FOVs illustrated and described herein. Any of these image sensor configurations may yield one or more of the advantages described herein, such as greater pixel density for improved detection/identification/tracking accuracy, larger overall FOV to reduce the likelihood of objects slipping outside of the FOV edges, and/or any other advantages described herein.

In any event, the combined FOVs (e.g., 336c, 346c, 356c) described herein enable the depth measurements of the stereovision perception systems of the maritime vehicle 100. As such, the maritime vehicle 100 described herein generally maintains at least objects of interest (e.g., targets) within the combined FOV to determine the three-dimensional (3D) position of such objects. FIG. 3D depicts a fourth example perception hardware configuration 360 that highlights the combined FOV and objects disposed within therein, in accordance with various embodiments described herein.

The fourth example perception hardware configuration 360 includes a frame 361 that is similar to the frame 212 and carries or houses a stereovision system 362 that includes, for example, a stereovision IR camera and a stereovision EO camera. The stereovision IR camera includes two IR image sensors that each have a FOV, resulting in a combined FOV 366. For example, the stereovision system 362 may be similar to the first example perception hardware configuration 330 of FIG. 3A, and the combined FOV 366 may be an extension of the combined FOV 336c.

Multiple objects 364a-d are disposed within the combined FOV 366. Thus, both the IR image sensors of the IR stereovision camera will capture radiation reflected or emitted from each of the objects 364a-d, but each of the objects 364a-d will be in a slightly different position within the images captured by the different IR image sensors. For example, the first object 364a will appear more towards the right edge of the left IR image sensor FOV than the first object 364a will appear relative to the right edge of the right IR image sensor FOV. This difference in perceived location represents the disparity between the two image sensors resulting from the baseline distance separating the two image sensors, and enables depth measurements based on these sets of images in accordance with the below equation:

$$D = \frac{fB}{δ} , \qquad ( 1 )$$

where D is the depth, f is the focal length of the image sensors, B is the baseline distance between the two image sensors, and δ is the disparity between the coordinate locations of an object in the two images.

To illustrate, the IR image sensors may each capture images featuring the object 364b, as represented by the lines of sight 368a, 369a of the respective imagers. The position of the object 364b within the respective images captured by the different IR image sensors is represented by the different angles 368b, 369b of the lines of sight 368a, 369a from the respective optical axes. The object 364b thus appears at different coordinate positions within the images captured by the different IR image sensors, such that the processing components described herein can determine the disparity between the two coordinate locations and the depth of the object 364b based on equation (1). Thus, each of the example perception hardware configurations illustrated herein enable depth measurements based on the principles represented by equation (1) because each hardware configuration includes stereovision cameras separated by a baseline distance.

FIG. 3E depicts a fifth example perception hardware configuration 370 configured to increase the baseline distance between image sensors 372a, 372b by physically staggering/offsetting the image sensors 372a, 372b within a frame 371, which in this example is similar to the frame 212. The image sensor FOVs 376a, 376b have optical axes 376a1, 376b1 that respectively correspond to the principal point of the FOVs 376a, 376b at any distance from the image sensors 372a, 372b. The FOVs 376a, 376b intersect/overlap at a particular distance from the image sensors 372a, 372b creating a composite FOV 376c and a blind spot 376d.

The image sensors 372a, 372b are staggered/offset within the frame 371 such that the first image sensor 372a is disposed proximate to a front edge 371a of the frame 371 and the second image sensor 372b is disposed proximate to a back edge 371b of the frame 371. In this manner, the image sensors 372a, 372b are separated by a staggered baseline distance 374b that is greater than the straight baseline distance 374a as a function of the angular separation 374c between the two baseline distances 374a, 374b. Notably, this configuration 370 can maximize the baseline distance between sensors in limited-space scenarios where the total available (i.e., possible) baseline distance is minimal (e.g., less than 1 m). In such limited-space scenarios (e.g., surgical robots, trucks), this fifth example perception hardware configuration 370 can be the only available option to increase the baseline distance when other methods for artificially doing so (e.g., weaving along a path) are unavailable.

In some embodiments, the image sensors 372a, 372b illustrated in FIG. 3E are part of stacks of individual image sensors that correspond to different stereovision cameras. For example, the image sensor 372b may be one sensor of a sensor stack 378 that is depicted from a top-down view and includes multiple image sensors that are part of different stereovision cameras. The straight-on view 379 of the sensor stack 378 shows the image sensor 372b disposed on top of another image sensor 372c. This image sensor 372c may be part of a different stereovision camera (e.g., EO) than the image sensor 372b (e.g., IR) and may have a corresponding image sensor disposed under/above the image sensor 372a.

FIG. 3F depicts a sixth example perception hardware configuration 380 configured to increase the combined FOV used to perceive target objects of the maritime vehicle 100 (or other device/system employing the vision system 200). Namely, the sixth example perception hardware configuration 380 includes multiple image sensors 381, 382, 383, and 384 oriented in a manner such that their respective FOVs 390, 391, 392, and 393 overlap near their respective edges. The right edge of the first FOV 390 of the first image sensor 381 may overlap with the left edge of the second FOV 391 of the second image sensor 384, the right edge of the second FOV 391 of the second image sensor 384 may overlap with the left edge of the third FOV 393 of the third image sensor 382, and the right edge of the third FOV 393 of the third image sensor 382 may overlap with the left edge of the fourth FOV 392 of the fourth image sensor 383. The various image sensors 381-384 may have corresponding optical axes (e.g., optical axes 394, 395, 396, and 397) that may generally represent the orientation of the corresponding image sensor.

In this manner, the perception systems described herein may detect/perceive and analyze target objects located within the combined FOV represented by the combination of the respective FOVs 390-393 to increase the capabilities of the perception systems to perceive target objects that are located in the direction of the forward orientation of the maritime vehicle 100 (which in this example is equivalent to the forward orientation of the frame 371, though that need not be the case). For example, the combination of the third image sensor 382 and the second image sensor 384 may comprise a stereovision camera. In certain embodiments, the stereovision camera may further comprise one or both of the first image sensor 381 and/or the fourth image sensor 383. In particular, this combination of image sensors and FOV orientations may increase the capabilities of the perception systems described herein to perform stereoscopic imaging techniques beyond a threshold distance from the maritime vehicle where the first FOV 390 and the fourth FOV 392 overlap with the second FOV 391 and the third FOV 393, as represented by the distance 388. Of course, it should be appreciated that the configuration 380 may be configured to capture image data of any suitable environment that is in any suitable location relative to the forward orientation of the maritime vehicle 100 (e.g., left, right, behind).

In some embodiments, the second FOV 391 and the third FOV 393 may each provide less than approximately 30° of visibility (e.g., represented by the first FOV angular width 386), while the first FOV 390 and/or the fourth FOV 392 may each offer at least approximately 65° of visibility (e.g., represented by the second FOV angular width 385). This configuration 380 may be particularly advantageous for maritime vehicles, as it allows for a broadened perspective, enhancing the vehicle's ability to detect and analyze target objects within its vicinity.

Furthermore, the orientation of the optical axes (e.g., optical axes 394, 395, 396, and 397) may be configured to optimize the performance of the vision/perception system. In certain embodiments, the second optical axis 395 and the third optical axis 396 may be angularly offset from the orientation of the maritime vehicle 100 (which in this example is the same as the orientation of the frame 371) by less than 10°, ensuring a focused forward view. As a result, the second optical axis 395 and the third optical axis 396 may be angularly offset from one another by less than approximately 10°, as well (e.g., as represented by the 6° angular offset 389). By contrast, the first optical axis 394 and/or the fourth optical axis 397 may be angularly offset by at least 10° from the orientation of the maritime vehicle 100. This arrangement may facilitate a wider perception range, enabling the maritime vehicle to more effectively monitor its surroundings. Moreover, such an arrangement ensures that the maritime vehicle may achieve a suitable balance between providing a wide-angle view combined FOV and maintaining sufficient overlap for stereo vision capabilities to accurately detect and analyze objects in the environment of the maritime vehicle 100 (or other device/system employing the vision system 200).

As mentioned, and in certain embodiments, the FOVs 390-393 may be oriented to overlap near their respective edges to ensure a seamless integration of the captured images. In these embodiments, the combined FOV may represent at least 150° of visibility. For example, the external edges of the first FOV 390 (e.g., the left edge of FOV 390) and the third FOV 392 (e.g., the right edge of FOV 392) may extend to within less than 10° of an orientation perpendicular to the orientation of the maritime vehicle 100. The example angle 387 may be approximately 9°, such that the total combined FOV of the maritime vehicle represented in FIG. 3F may be approximately 162°. However, the FOVs 390-393 may be oriented in a manner to achieve at least 180° (or more) of FOV coverage. For example, the maritime vehicle may comprise a plurality of imagers (not shown) configured to provide up to 360° of visibility around the maritime vehicle in combination with the stereovision camera (e.g., comprising up to image sensors 381-384). In this example, the plurality of imagers may comprise three or more image sensors (e.g., four, five, six, etc.), such that the total number of image sensors providing image data as part of the perception system may total any suitable number (e.g., four, seven, nine, etc.).

Such a comprehensive view may enable the perception systems described herein to perceive and respond to target objects located in various directions relative to their forward orientations, thereby significantly enhancing the navigational and operational capabilities of the perception systems. Additionally, by enabling management of the FOV 390-393 overlap for a maximum wide-angle view while continuing to accurately perform the stereovision functions described herein, these techniques more optimally balance the total FOV of the maritime vehicle with the desired stereovision capabilities, creating a more generally functional perception system than existing techniques. Thus, the configuration 380 represented in FIG. 3F represents an improvement in the field of maritime vehicle vision/perception systems, offering improved perception through a sophisticated arrangement of multiple image sensors. The system's ability to provide a wide and integrated view of the maritime vehicle's surroundings provides enhanced safety and efficiency in maritime operations relative to conventional techniques that could not perform effective, passive imaging techniques utilizing such a configuration.

Finally, although certain maritime vehicles have been described herein in accordance with the teachings of the present disclosure, the scope of coverage of this patent is not limited thereto. On the contrary, while the invention has been shown and described in connection with various preferred embodiments, it is apparent that certain changes and modifications, in addition to those mentioned above, may be made. This patent covers all embodiments of the teachings of the disclosure that fairly fall within the scope of permissible equivalents. Accordingly, it is the intention to protect all variations and modifications that may occur to one of ordinary skill in the art.

1. A vision system, comprising:
a frame comprising first and second openings; and
a stereovision camera disposed within the frame, the stereovision camera comprising:
a first image sensor with a first field of view (FOV) having a first optical axis, the first image sensor being disposed immediately adjacent to the first opening, and
a second image sensor with a second FOV having a second optical axis that is not parallel with the first optical axis, the second image sensor being disposed immediately adjacent to the second opening, wherein both the first image sensor and the second image sensor are passive sensors.

2. The vision system of claim 1, wherein the first image sensor is a first infrared (IR) image sensor, the second image sensor is a second IR image sensor, and the vision system further comprises at least two electro-optical (EO) image sensors including a first EO image sensor with a first EO FOV and a second EO image sensor with a second EO FOV.

3. (canceled)

4. The vision system of claim 1, wherein the first image sensor is a monochrome image sensor and the second image sensor is a multi-color sensor.

5. (canceled)

6. The vision system of claim 1, wherein a first edge of the first FOV is oriented to be substantially parallel with a second edge of the second FOV.

7. (canceled)

8. The vision system of claim 1, wherein at least one of the first optical axis or the second optical axis is angularly offset from an orientation of the frame.

9. The vision system of claim 1, wherein a first orientation of the first FOV is different than a second orientation of the second FOV.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. The vision system of claim 1, wherein the first image sensor is disposed proximate to a front edge of the frame and the second image sensor is disposed proximate to a back edge of the frame, such that the first image sensor is physically staggered within the frame relative to the second image sensor.

23. The vision system of claim 1, wherein the first image sensor is oriented away from the second image sensor and the second image sensor is oriented away from the first image sensor.

24. The vision system of claim 1, wherein the stereovision camera further comprises:
a third image sensor having a third FOV having a third optical axis; and
a fourth image sensor having a fourth FOV having a fourth optical axis.

25. (canceled)

26. (canceled)

27. (canceled)

28. (canceled)

29. The vision system of claim 24, wherein the first optical axis and the second optical axis are angularly offset from an orientation of the frame by less than 10° and the third optical axis and the fourth optical axis are angularly offset from the orientation of the frame by at least 10°.

30. The vision system of claim 24, wherein the first optical axis, the second optical axis, the third optical axis, and the fourth optical axis are oriented such that a combined FOV comprised of the first FOV, the second FOV, the third FOV, and the fourth FOV represents at least 150° of visibility.

31. A vision system, comprising:
a frame comprising first and second openings; and
a stereovision camera disposed within the frame, the stereovision camera comprising:
a first image sensor with a first field of view (FOV) representing at least 65° of visibility, the first image sensor being disposed immediately adjacent to the first opening, and
a second image sensor with a second FOV representing less than 55° of visibility, the second image sensor being disposed immediately adjacent to the second opening, wherein both the first image sensor and the second image sensor are passive sensors.

32. The vision system of claim 31, wherein the first image sensor is a first infrared (IR) image sensor, the second image sensor is a second IR image sensor, and the vision system further comprises at least two electro-optical (EO) image sensors including a first EO image sensor with a first EO FOV and a second EO image sensor with a second EO FOV.

33. The vision system of claim 31, wherein the first FOV has a first optical axis and the second FOV has a second optical axis that is not parallel with the first optical axis, and wherein at least one of the first optical axis and the second optical axis is angularly offset from an orientation of the frame.

34. The vision system of claim 31, wherein the first image sensor is a monochrome image sensor and the second image sensor is a multi-color sensor.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. The vision system of claim 31, wherein the first image sensor is disposed proximate to a front edge of the frame and the second image sensor is disposed proximate to a back edge of the frame, such that the first image sensor is physically staggered within the frame relative to the second image sensor.

53. The vision system of claim 31, wherein the first image sensor is oriented away from the second image sensor and the second image sensor is oriented away from the first image sensor.

54. The vision system of claim 31, wherein the stereovision camera further comprises:
a third image sensor having a third FOV having a third optical axis; and
a fourth image sensor having a fourth FOV having a fourth optical axis.

55. (canceled)

56. (canceled)

57. (canceled)

58. (canceled)

59. The vision system of claim 54, wherein the first optical axis and the second optical axis are angularly offset from an orientation of the frame by less than 10° and the third optical axis and the fourth optical axis are angularly offset from the orientation of the frame by at least 10°.

60. (canceled)

61. A vision system, comprising:
a frame comprising first and second openings; and
a stereovision camera disposed within the frame, the stereovision camera comprising:
a first image sensor with a first field of view (FOV) having a first optical axis, the first image sensor being disposed immediately adjacent to the first opening, and
a second image sensor with a second FOV having a second optical axis, the second image sensor being disposed immediately adjacent to the second opening,
wherein (i) the second optical axis is not parallel with the first optical axis, and/or (ii) the first FOV is larger than the second FOV, and wherein both the first image sensor and the second image sensor are passive sensors.

62. The vision system of claim 61, wherein the first image sensor is a first infrared (IR) image sensor, the second image sensor is a second IR image sensor, and the vision system further comprises at least two electro-optical (EO) image sensors including a first EO image sensor with a first EO FOV and a second EO image sensor with a second EO FOV.

63. (canceled)

64. The vision system of claim 61, wherein the first image sensor is a monochrome image sensor and the second image sensor is a multi-color sensor.

65. (canceled)

66. The vision system of claim 61, wherein a first edge of the first FOV is oriented to be substantially parallel with a second edge of the second FOV.

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. The vision system of claim 61, wherein the first image sensor is disposed proximate to a front edge of the frame and the second image sensor is disposed proximate to a back edge of the frame, such that the first image sensor is physically staggered within the frame relative to the second image sensor.

86. The vision system of claim 61, wherein the first image sensor is oriented away from the second image sensor and the second image sensor is oriented away from the first image sensor.

87. The vision system of claim 61, wherein the stereovision camera further comprises:
a third image sensor having a third FOV having a third optical axis; and
a fourth image sensor having a fourth FOV having a fourth optical axis.

88. (canceled)

89. (canceled)

90. (canceled)

91. (canceled)

92. The vision system of claim 87, wherein the first optical axis and the second optical axis are angularly offset from an orientation of the frame by less than 10° and the third optical axis and the fourth optical axis are angularly offset from the orientation of the frame by at least 10°.

93. (canceled)

94. (canceled)

95. (canceled)

96. A maritime vehicle, comprising:
a hull;
a housing coupled to the hull; and
the vision system of claim 61, wherein the frame is carried by the housing.

97. (canceled)

98. The maritime vehicle of claim 96, wherein at least one of the first optical axis or the second optical axis is angularly offset from an orientation of the maritime vehicle.

99. (canceled)

100. (canceled)

101. The maritime vehicle of claim 96, further comprising a plurality of imagers configured to provide up to 360° of visibility around the maritime vehicle in combination with the stereovision camera.
